(19) United States
(12) Patent Application Publication
(10) Pub. No.: US 2013/0018812 A1
(43) Pub. Date: Jan. 17, 2013

(54) System for Regulation of Continuing Education Requirements

(71) Applicants: Eugene H. Cherner, Lombard, IL (US); Steve R. Fialko, Wheeling, IL (US)

(72) Inventors: Eugene H. Cherner, Lombard, IL (US); Steve R. Fialko, Wheeling, IL (US)

(73) Assignee: CE CONVERGENCE, LLC, Erie, PA (US)

(21) Appl. No.: 13/180,200

(22) Filed: Jul. 11, 2011

(51) Int. Cl. G06Q 50/00

(52) U.S. Cl. 705/327

(57) ABSTRACT

Various embodiments are directed to a Continuing Education Registration and Search System to allow various users of the System to track, search, register, audit and/or manage various aspects of their continuing education requirements. The System may provide a plurality of user interfaces over various computer networks for use by various users where all continuing education information can be exchanged between the various users. The various users in the System may have accounts in the System, search through a variety of classes and providers with user provided feedbacks, and register for and purchase classes within the System. The System may also provide the current status and remaining requirements to the users and update the status and remaining requirements as classes are taken and completed by users. The System may also provide recommendations of classes to the users based at least in part on information stored within the System.

### BACKGROUND OF THE INVENTION

Professionals, for example, licensed accountants, lawyers, professional engineers, and the like are required to adhere to specific continuing education requirements and associated deadlines to maintain a valid license to practice. These regulations are set forth, mandated, and periodically updated by their respective governing bodies. Oftentimes, these regulations are unique to each state and professionals who may be licensed in various jurisdictions under various governing bodies, will find it especially tedious to track their continuing education compliance. With the continuing rise in continuing education requirements in various jurisdictions for various professionals, it has become increasingly difficult for professionals to track, manage, and/or satisfy their continuing education requirements. Non-compliance will often lead to loss of license and malpractice.

Additionally, companies and corporations who regularly employ professionals under various laws may be subject to audits by the governing body in various jurisdictions to ensure compliance with varying laws. If a professional who was practicing at the company does not satisfy the appropriate continuing education requirements for each jurisdiction they are licensed to practice in, fines and sanctions may be levied against the company for non-compliance. Given that a company may employ hundreds and even thousands of professionals all with varying continuing education requirements and in various jurisdictions, a systematic and organized means is necessary to navigate the complexities associated with managing continuing education requirements of the professionals.

Licensing bodies in many jurisdictions will audit various companies and their professionals to ensure compliance with the current continuing education requirements. Due to the high number of professionals that must be audited, some licensing bodies are forced to use a random auditing system where only a limited percentage of the professionals are licensed to practice within the jurisdiction.

The present invention centralizes class offerings, locations, providers, costs, and class recommendations to help professionals make more informed decisions about their continuing education requirement. Furthermore, the present invention also assists companies in ensuring that they remain compliant with various jurisdictional requirements of various governing bodies and accreditations. This helps to automate the process of complying with continuing education requirements, reducing the risk of non-compliance, saving time, and providing cost savings. Licensing bodies may also use the system to efficiently gather detailed information regarding the compliance of continuing education requirements of the companies and professionals.

### SUMMARY OF THE INVENTION

Various embodiments are directed to a Continuing Education Registration and Search System for managing and tracking continuing education requirements and purchasing of continuing education content.

Therefore, it is an object of the present invention to provide a method, a computer-readable storage medium storing computer-executable instructions to perform a method, and a system for search, registration, management, auditing, and tracking of continuing education requirements, According to the present invention, the system including at least one web server having a processor adapted to execute computer executable modules and a memory coupled to the processor, the at least one web server configured to communicate with at least one user computer via at least one user computer network, wherein the memory includes at least one computer executable module, which, when executed by the processor, cause the processor to transmit data to the at least one user computer configured to generate at least one of a plurality of user interfaces, the plurality of user interfaces comprising a professional interface, a corporate interface, a licensing body interface, and/or a provider interface; build at least one account associated with at least one user; store at least one class associated with at least one attribute based at least partially upon data received from at least one user computer; transmit search result data to the at least one user computer at least partially based upon at least one received search query from the at least one user computer; transmit recommendation data, including class identification data, to the at least one user computer based at least partially on the result data; generate registration data for at least one user at least partially based upon at least one received class selection from the at least one user computer; generate completion data for at least one user at least partially based upon at least one received notification from the at least one user computer; and transmit status data for the at least one user to the at least one user computer.

The system further includes computer executable modules, which, when executed by the processor causes the processor to update a favorite providers list in at least one user interface of the plurality of user interfaces as the at least one user modifies at least one provider in the favorite providers list; and update a class wishlist in at least one user interface as the at least one user modifies at least one class in the class wishlist.

The system further includes computer executable modules, which, when executed by the processor, causes the processor to generate status data of the at least one user based on the current requirements of the jurisdiction and accreditation of the licensing body and persistent data of the at least one user; and transmit at least one notification to at least one user computer to notify continuing education requirements of the at least one user.

The system further includes computer executable modules, which, when executed by the processor, causes the processor to transmit feedback data associated with the at least one class and at least one provider to the at least one user computer; receive feedback data for a class of the at least one class and a provider for the at least one provider from the at least one user computer; generate statistical data at least partially based on the feedback data associated with each class and each provider; and output the statistical data to the provider interface for a provider.

The system further includes a computer executable modules, which, when executed by the processor, causes the processor to enable an administrative assistant to register the at least one class for at least one professional based on access permissions data; and enable a corporate manager to register the at least one class for the at least one professional based on linked accounts data.

The system further includes a computer executable modules, which, when executed by the processor, causes the processor to link a corporate manager account to at least one professional account to enable the corporate manager to register the at least one class for the at least one professional; and link an administrative assistant account to at least one professional account to enable the administrative assistant to register the at least one class for the at least one professional based on access permissions data for each professional.

The system further includes a computer executable modules, which, when executed by the processor causes the processor to transmit class wishlist data to the at least one user computer for display to the at least one user; update the class wishlist data associated with an account of the at least one user in response to a modification to a class wishlist by the at least one user; and update the class wishlist data associated with the account of the at least one user when a class registered by the at least one user is already full.

The system wherein the memory further includes computer executable modules, which, when executed by the processor, causes the processor to transmit favorite provider list data to the at least one user computer for display to the at least one user; and update the favorite provider list data associated with an account of at least one user in response to a modification of a favorite provider list by the at least one user.

The system further includes a computer executable modules, which, when executed by the processor, causes the processor to store continuing education credit information based at least partially upon data received from the at least one user for credits received by an external provider, the continuing education credit information including location, credit hours, class name, provider of the class, type of class, date of class, the accreditation of the class, jurisdiction of the class, and/or reporting period.

The system further includes computer executable modules, which, when executed by the processor, causes the processor to transmit the status data for at least one user to at least one user computer based on linked accounts data.

The system wherein the memory further includes computer executable modules, which, when executed by the processor, causes the processor to transmit the status data for at least one user to at least one user computer based on access permissions data associated with an account of the at least one user; and generate at least one report at least partially based on the access permissions data associated with the account of the at least one user.

The system wherein the memory further includes computer executable modules, which, when executed by the processor, causes the processor to transmit the status data for a plurality of users to the licensing interface on at least one user computer for audit based on access permissions of the licensing body, wherein at least two users of the plurality of users are associated with different companies.

The system wherein the memory further includes computer executable modules, which, when executed by the processor, causes the processor to update an account associated with a corporate manager as the corporate manager registers, switches, and/or cancels at least one professional for a class, manages a class wishlist associated with the corporate manager account, manages a favorite providers list associated with the corporate manager account, and/or provides feedback information; update an account associated with a professional as the professional registers, switches, and/or cancels a class, manages a class wishlist associated with the professional account, manages a favorite providers list associated with the professional account, provides feedback information, and/or completes a class; update an account associated with a licensing body as the licensing body transmits notifications, updates rules and/or regulations, and/or audits professionals; update an account associated with an administrative assistant as the administrative assistant links with the professional account; and update an account associated with a provider as the provider uploads class offerings, updates class offerings, and/or receives and responds to feedback.

The system wherein the at least one received search query includes at least one search criteria and the at least one search criteria is a search by date, search by cost, search by review, search by location, search by subject, search by keywords, search by hours, search by provider, and/or search by accreditation.

The system wherein the at least one attribute includes class name, provider name, instructor name, cost, accreditation, credit hours, and feedback information.

The system wherein a report in the at least one report is a certificates of completion, complete history, history by period, current status, remaining requirements, future requirements, class wishlist, licensing agency, and/or payment history.

The system wherein each account of the at least one account is associated with persistent data that includes rules and regulations data, notifications data, shopping cart data, class data including class identification data, status data, registration data, recommendation data, search result data, wishlist data, favorite provider list data, access permission data, registered classes, login information, completed classes, accreditation and license number, personal messages, linked accounts data, notifications, payment information, first name and last name, phone number, address, zip code, and/or email address.

The system wherein the status data includes a number of continuing education credits received, total continuing education credits required, total remaining continuing education credits needed, and/or compliance information.

According to the present invention, also provided is a method for providing search, registration, management, auditing, and tracking of continuing education requirements, the method includes transmitting, by a web server, data to at least one user computer configured to generate at least one of a plurality of user interfaces, the plurality of user interfaces comprising a professional interface, a corporate interface, a licensing body interface, and/or a provider interface; building at least one account associated with at least one user; storing at least one class associated with at least one attribute based at least partially upon data received from at least one user computer; transmitting search result data to the at least one user computer at least partially based upon at least one received search query from the at least one user computer; transmitting recommendation data, including class identification data, to the at least one user computer based at least partially on the result data; generating registration data for at least one user at least partially based upon at least one received class selection from the at least one user computer; generating completion data for at least one user at least partially based upon at least one received notification from the at least one user computer; and transmitting status data for the at least one user to the at least one user computer.

According to the present invention, also provided is a computer-readable storage medium storing computer-executable instructions that, when executed, cause a computer system to perform a method for searching, registering, auditing, managing and tracking of continuing education requirements, the method includes transmitting, by a web server, data to at least one user computer configured to generate at least one of a plurality of user interfaces, the plurality of user interfaces comprising a professional interface, a corporate interface, a licensing body interface, and/or a provider interface; building at least one account associated with at least one user; storing at least one class associated with at least one attribute based at least partially upon data received from at least one user computer; transmitting search result data to the at least one user computer at least partially based upon at least one received search query from the at least one user computer; transmitting recommendation data, including class identification data, to the at least one user computer based at least partially on the result data; generating registration data for at least one user at least partially based upon at least one received class selection from the at least one user computer; generating completion data for at least one user at least partially based upon at least one received notification from the at least one user computer; and transmitting status data for the at least one user to the at least one user computer.

### BRIEF DESCRIPTION OF THE DRAWINGS

FIG. 1 illustrates an embodiment of a Continuing Education Registration and Search (CERS) System;

FIG. 2 illustrates an embodiment of a logic flow for the CERS System;

FIG. 3 illustrates an embodiment of a logic flow for interactions between a professional and the CERS System of the present invention;

FIG. 4a illustrates an embodiment of a logic flow between a professional and the CERS System;

FIG. 4b illustrates an embodiment of a logic flow between a corporate manager and CERS System;

FIG. 4c illustrates an embodiment of access permissions for a corporate manager within the CERS System;

FIG. 5 illustrates an embodiment of a logic flow for providing and reviewing feedback information within the CERS System;

FIG. 6 illustrates an embodiment of a logic flow for entering manual certification information in the CERS System;

FIG. 7 illustrates an embodiment of a logic flow for obtaining reporting information from the CERS System;

FIG. 8 illustrates an embodiment of a logic flow for updating classes within the CERS System;

FIG. 9a-9d illustrate embodiments of the CERS System user interface; and

FIG. 10 illustrates an embodiment of a computer system used in the present invention.

### DESCRIPTION OF THE PREFERRED EMBODIMENTS

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

References throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

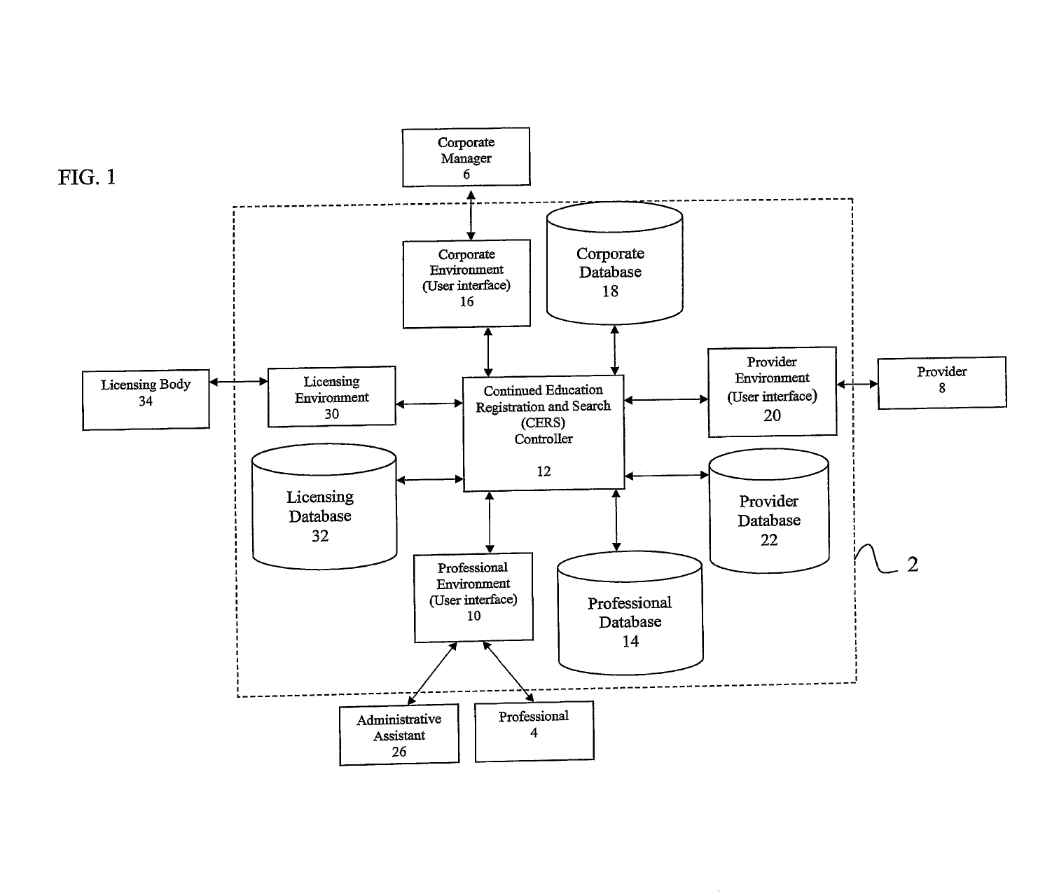

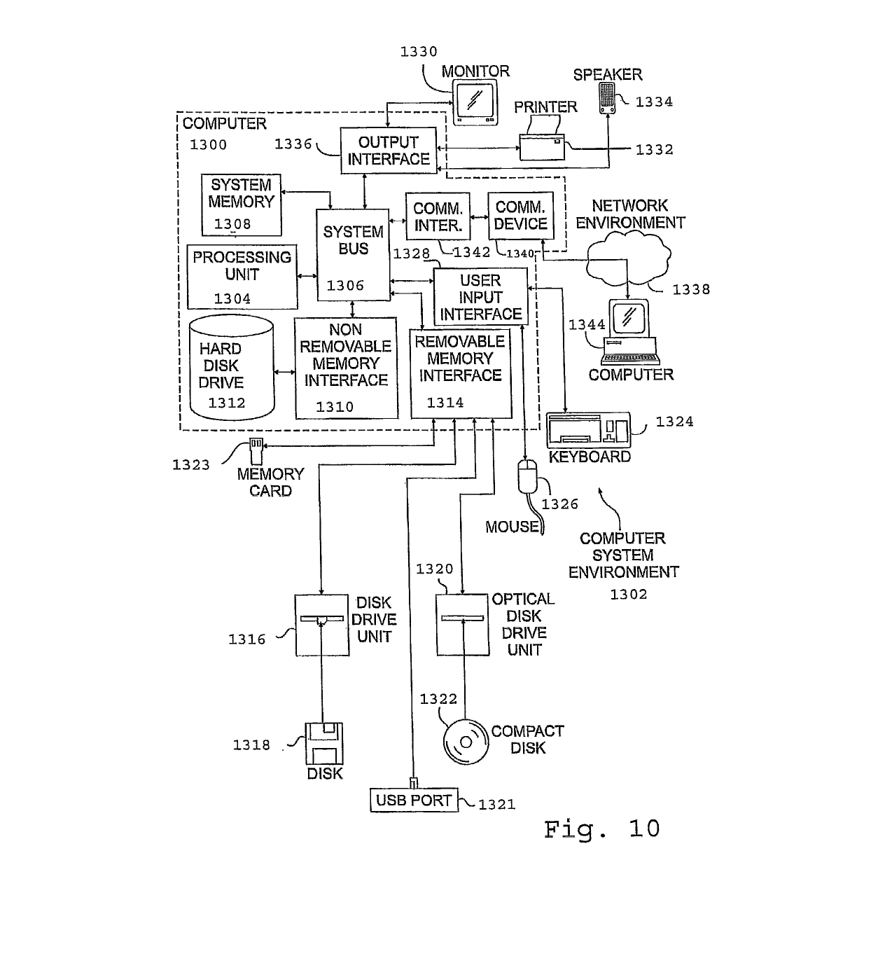

FIG. 1 illustrates an embodiment of the continuing CERS System 2 having a number of components that provide flexibility in registering, searching, and purchasing continuing education content. Although FIG. 1 may show a limited number of components, it can be appreciated that a greater or fewer numbers of components may be employed for a given implementation. In a non-limiting exemplary embodiment, the Corporate Database 18, the Professional Database 14, Licensing Database 32, and the Provider Database 22, may all be implemented within a single database coupled to the CERS Controller 12. Moreover, the single database may store the data/information within each of the databases into one or more tables within the single database or any other logical and/or physical boundaries known to those skilled in the art for storing and/or separating data/information in a database. In another non-limiting exemplary embodiment, the CERS System 2 may provide one or more Corporate Environments 16 or Corporate Interfaces, one or more Professional Environments 10 or Professional Interfaces, one or more Licensing Environments 30 or Licensing Interfaces, and/or one or more Provider Environments 20 or Provider Interfaces for access by one or more Corporate Managers 6, Professionals 4, one or more Licensing bodies 34, and/or one or more Providers 8. In another non-limiting exemplary embodiment, the CERS Controller 12 may be implemented on a computer, such as Computer 1300 illustrated in FIG. 10 executing software modules.

In various embodiments, users, for example, an Administrative Assistant 26, a Professional 4, a Corporate Manager 6, a Provider 8, and/or Licensing Body 34 may all use the CERS System 2 together to benefit each other. In addition, in various embodiments, it is to be understood that the CERS System 2 may be used concurrently by all users. An Administrative Assistant 26 may include, but not limited, to secretaries, project managers, or any other person who is given access permissions to perform any of the functionality on behalf of the Professional 4 within the CERS System 2. A professional may include, but not limited to, doctors, lawyers, accountants, nurses, insurance, real estate agents, engineers, teachers, and/or any other person that may have a continuing education requirement. The Corporate Manager 6 may include, but not limited to, executive officers, compliance managers, project managers, team leaders, and/or any other person who may be directly or indirectly responsible for tracking the continuing educational needs of a Professional 4. The Provider 8 may be a continuing education provider who may provide a list of classes to the CERS System 2 available for the Professional 4 to attend. For example, Provider 8 may include, but not limited to, continuing education providers, such as American Institute of CPAs, Illinois CPA Society, Pennsylvania Institute of CPAs, Western CPE, CPE Inc., Practicing Law Institute (PLI), American Medical Association (AMA), and/or any other entity that may provide a list of classes that can be registered or attended by the professional. The Licensing Body 34 may include, but not limited to, any governmental agency or boards that promulgates regulation or set forth a set of continuing education requirements for professionals licensed within the Licensing Body's 34 territory or jurisdiction, or any entity delegated with the duty by a governmental agency or boards to check compliance of continuing education requirements by professional via various mechanisms of auditing.

In various embodiments, each user may also have an account in the CERS System 2. The account may be used to identify the particular user in the CERS System 2. In one embodiment, upon first use of the CERS System 2, the CERS System 2 may prompt the user to create an account including login information. In response, the CERS System 2, may build and/or create an account associated with the particular user and store and/or archive the account in one or more databases. Furthermore, each user's account may be associated with or include persistent data unique to each user in the CERS System 2 and the persistent data may be updated and/or modified by the CERS System 2 as the users modify the various aspects of their account associated with the persistent data. Persistent data may include, but not limited to, rules and regulations data, notifications data, completion data, shopping cart data, class data including class identification data, status data, registration data, recommendation data, search result data, wishlist data, favorite provider list data, access permission data, registered classes, login information, completed classes, accreditation and license number(s), personal messages, linked accounts data, notification, payment information, first name and last name, phone number(s), address(es), zip code, and/or email address(es). Additionally, the login information may include, but not limited to, a user name and password, a user name and a hashed/encrypted password, a one time key, a single unique identifier, and/or any other information that may be used to identify and authenticate the user in the CERS System 2. Further, some persistent data may be unique to particular users such as, for example, rules and regulations data of licensing bodies.

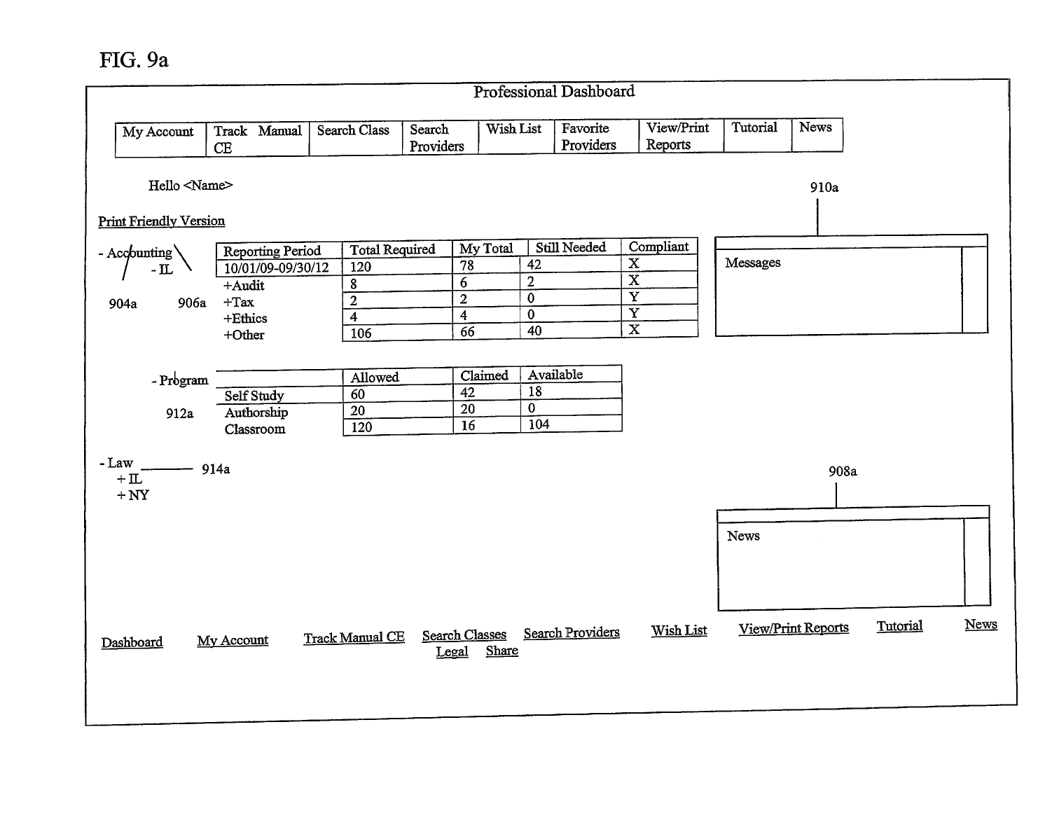

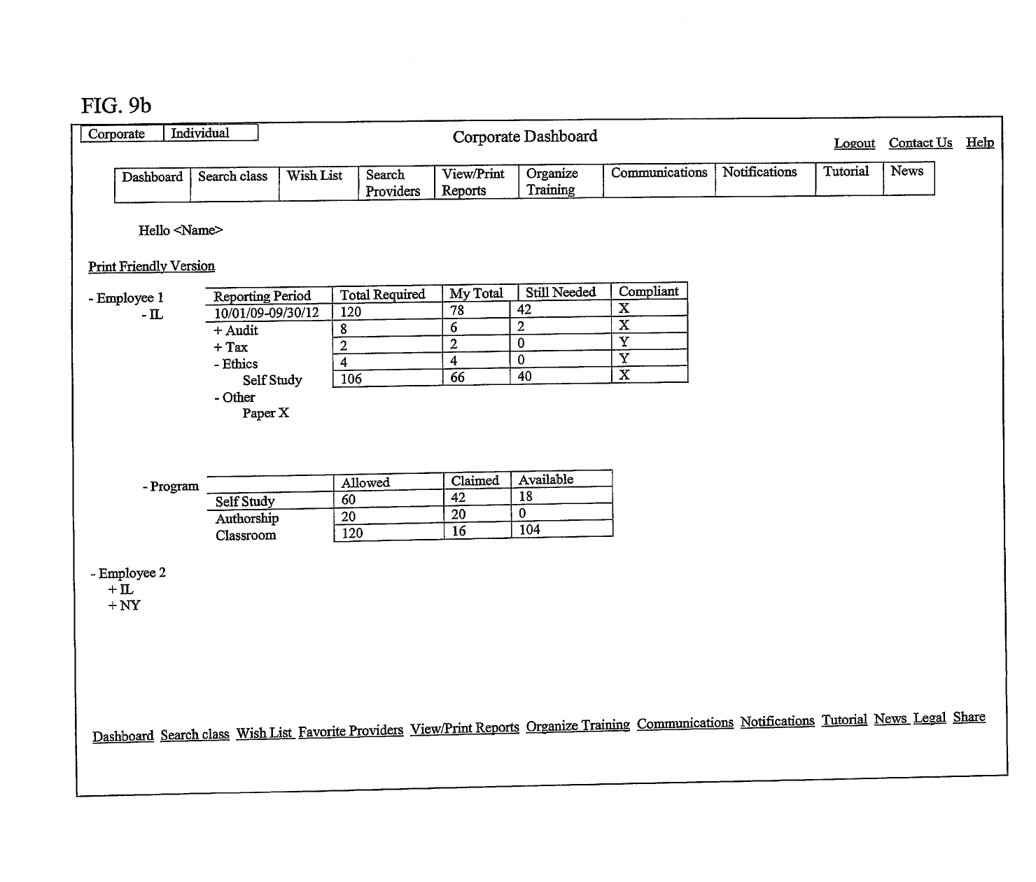

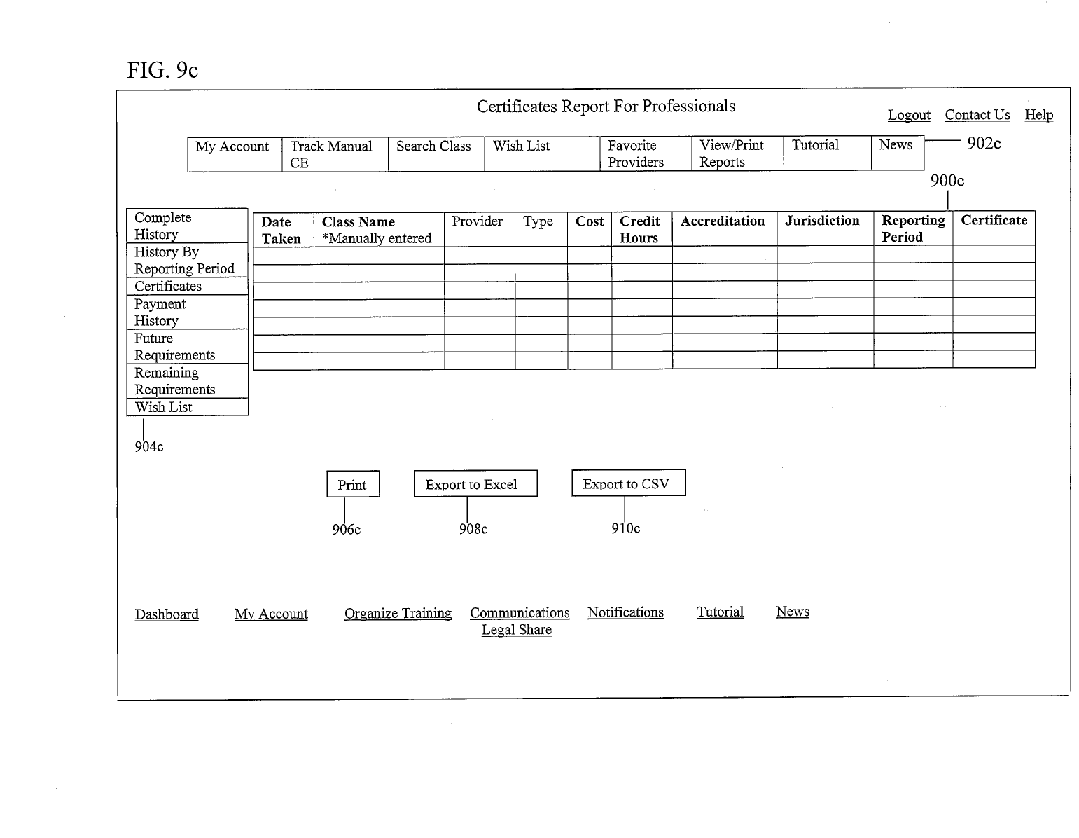

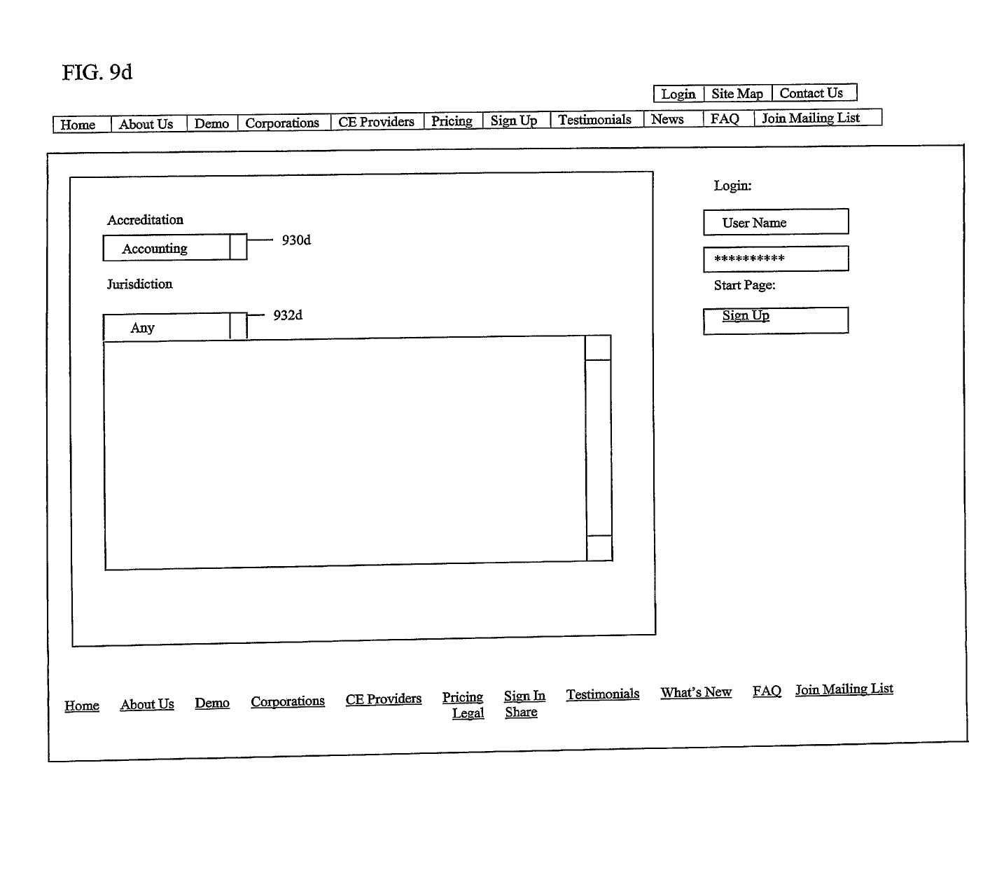

In various embodiments described herein, the CERS System 2 may offer a Licensing Environment, a Professional Environment, a Provider Environment, and a Corporate Environment. The Professional Environment provides the professional user interfaces to manage their continuing education requirements and certifications. The Provider Environment provides a user interface for continuing education providers to offer classes for registration and purchase, obtain feedback, gather reports, update class offerings and various other functions described herein. The Corporate Environment provides a corporate compliance manager access into all constituent individuals. The corporate compliance manager may use the CERS System 2 to organize, train, maintain organization charts, manage messages, alerts, news, notifications for users, and reporting for the corporation. In addition, the account settings, preferences, and personal information can be updated by either the professional or the corporate compliance manager. The licensing view provides a licensing board or agency the user interfaces to gather reports and assist the licensing board or agency in auditing the professionals within the CERS System 2. If the notifications are given to a constituent or professional, they may also be sent to the corporate compliance manager in order to maintain the individual's account information. Additionally, in cases where the corporate compliance manager, such as for example Corporate Manager 6 of FIG. 1, may also have continuing education requirements, the CERS System 2, as illustrated in FIG. 9b, may provide the Corporate Manager 6 the option to change from the Corporate Environment to the Professional Environment and vice versa in order to review and manage their individual account. To accomplish this, the CERS System 2, may provide in the Professional Environment or the Corporate Environment a widget selectable by the Corporate Manager 6 to toggle between a Corporate Manager account and a Professional account.

In another embodiment of FIG. 1, the Administrative Assistant 26 and the Professional 4 may access the CERS System 2 through a Professional Environment 10 which includes a user interface coupled to the CERS Controller 12. The CERS Controller 12 may provide the access to the CERS System 2 via a user interface displayed in Professional Environment 10 to the Professional 4. To further reduce the burden on professionals in managing their continuing education requirements, an administrative assistant, such as Administrative Assistant 26, may also access the Professional Environment 10 to for example, register, cancel, or switch classes on behalf of one or more professionals. Moreover, access permissions may be granted by a professional such as Professional 4 to the Administrative Assistant 26 account to perform all, a portion, or a single functionality within Professional Environment 10 on behalf of the Professional 4. Additionally, the Administrative Assistant's 26 account may be linked to one or more professional accounts to provide the Administrative Assistant 26 with access to multiple professionals where each professional may have their own set of access permissions granted to the Administrative Assistant's 26 account. In a non-limiting exemplary embodiment, a professional may allow the Administrative Assistant 26 to register and switch classes but a different professional may only allow the same Administrative Assistant 26 to only register for classes. Accordingly, it may be appreciated that description with respect to the functionality of the Professional Environment 10 described herein after are equally applicable to the administrative assistant accessing the CERS System 2 via the Professional Environment 10 using a administrative assistant account unless specifically disclosed otherwise. The CERS Controller 12 may store the Administrative Assistant 26 or the Professional's 4 account and any accompanying persistent data in Professional Database 14 and may access this information and provide timely messages to the Professional 4 or the Administrator 26 through the Professional Environment 10 while the Professional 4 is accessing the CERS System 2 and viewing their information. Alternatively, the Administrator's 26 account may also be stored in a separate database (not shown).

In another embodiment of FIG. 1, a Corporate Manager 6 may access the CERS System 2 through a Corporate Environment 16, which includes a user interface coupled to the CERS Controller 12. In many instances, the Corporate Manager 6 is in place for companies that must monitor the corporate requirements for their constituent employees. In addition to all of the individual constituents that make up the corporation, other capabilities may be provided to the Corporate Manager 6 to efficiently manage the constituent employees for example, the Professional 4. A Corporate Database 18 may retain corporate information that is needed to provide these features to a Corporate Manager 6. The Corporate Database 18 may include one or more company tables and may store company/corporate information for one or more companies/corporations in the one or more company tables.

In another embodiment of FIG. 1, a provider may access the CERS System 2 through a Provider Environment 20. The Provider 8 may be a content provider and may use a Provider Environment 20 which includes a user interface to enable the Provider 8 to provide one or more classes to the CERS System 2 for registration by the Professional 4 and/or the Corporate Manager 6. These classes may then become available for the Professional 4 and/or Corporate Manager 6 to register and allow the Professional 4 to attend. The CERS System 2 may store the provider class information in the Provider Database 22 coupled to the CERS Controller 12 along with other pertinent information about the Provider 8, as described herein. The Provider Database 22 is the repository for the class content or data of the Provider 8 and may include one or more tables to store class content or data for each Provider 8. Furthermore, the class content or data may include class identification data such as, for example, a unique identifier and/or name of the class to identify the class for users and the CERS System 2.

In another embodiment of FIG. 1, a Licensing Body 34 may access the CERS System 2 through a Licensing Environment 30. The Licensing Body 34 may include regulatory agencies who are auditing professionals and/or companies to ensure their compliance with continuing education requirements within the jurisdiction of the Licensing Body 34. Additionally, the Licensing Body 34 may also include any entity delegated with the duty to audit professionals and/or companies to ensure compliance with continuing education requirements within the jurisdiction of a licensing body. The Licensing Body 34 may provide updated continuing education requirements and may communicate or notify Corporate Manager's 6 and Professional 4 regarding any pending audits by the Licensing Body 34. Additionally, the Licensing Body 34 may also obtain various reports described herein to verify compliance by various companies and professionals with continuing education requirements. As the Licensing Body 34 provides continuing education requirements within the CERS System 2, the rules and regulations data associated with the account of the Licensing Body 34 may be updated with the new continuing education requirements. The communication messages, including message relating to notifications for auditing, between the Licensing Body 34 and the Professional 4 or the Corporate Manager 6 may also be stored within the Licensing Database 32 in the form of notifications data.

In various embodiments, the CERS System 2 may provide the information to the users by using the CERS Controller 12 to create content that responds to requests from the Licensing Body 34, Professional 4, Administrative Assistant 26, Provider 8, and Corporate Manager 6. As the information from the Provider 8 is placed into the CERS System 2 via the Provider Environment 20, changes may propagate throughout the CERS System 2 and in turn, making the classes or updates to classes available to the users. In order to add a class to the CERS System 2, the Provider 8 may be required to provide at least some of information relating to the geographical, physical, and/or virtual location (URI/URL) of the class, class name, number of participants, instructor name, concepts, agenda for the class, costs information, accreditation, provider, credit hours, and/or other information that is needed to determine whether a class may fit the Professional's 4 needs. Both the Corporate Environment 16 and the Professional Environment 10 may display a list of classes available to the Professional 4. After the classes become available in the CERS System 2 for registration, the Professional 4 may choose to register for classes in the lists provided in the Professional Environment 10. Additionally, the Corporate Manager 6 may also register his constituents, for example, Professional 4, for classes in the class list provided in the Corporate Environment 16. After registration, the Professional Environment 10 or the Corporate Environment 16 may send the registration information or data to CERS Controller 12. To synchronize CERS System 2 with the Provider's 8 systems, CERS System 2 may populate the registration information or data into the Professional's 4 account (not shown) and send a confirmation to the Provider 8. After a user, for example Professional 4, has completed a class, the CERS Controller 12 may be notified by Provider 8 regarding the completion of the attended class by the Professional 4. Subsequently, the CERS Controller 12 may place a completed status in the Professional's 4 account, archive or store the Certificate of Completion forwarded by the Provider 8 to the CERS Controller 12 and update the Professional's 4 current status and remaining continuing education requirements which may include, but not limited to, continuing education credits received, total continuing education credits required, total remaining continuing education credits needed, and compliance information.

In various embodiments, the CERS System 2 may provide the user interface in the Professional Environment 10, the Corporate Environment 16, the Provider Environment 20, and the Licensing Environment 30 in a web browser (not shown) such as Internet Explorer, Firefox, Chrome, and/or any other suitable web browser in accordance with the described embodiments. In various embodiments, the web browser may be implemented by a computer and/or by a mobile device, and may support computer programming languages, standards, web protocols and/or technologies required by the CERS System 2 to communicate with the users via their respective environments. Such computer programming language standards, web protocols, and/or technologies may include, but are not limited to, HTML, XHML, XML, ActionScript, JavaScript, ECMAScript, Jscript, Basic, Visual Basic, VBScript, CSS, Asynchronous JavaScript, and XML (Ajax), Java, Python, Perl, C#/.net and/or any other suitable programming, scripting or VM-based languages. To support the various programming language standards, web protocols and/or technologies, the web browser may include a language interpreter such as a script and/or runtime interpreter for computer programming languages such as JavaScript®, ActionScript®, VBScript®, C#, Jscript, or any other scripted and/or interpreted programming languages that are interpreted in real time by the script, and/or runtime interpreter which may be implemented within the web browser or by a plugin. The runtime interpreters may include, but not limited to, Flash® or Silverlight® or any other software module that executes source code, executes intermediate code translated from source code, or executes precompiled source code. Accordingly, in various embodiments, the CERS Controller 12 may be coupled to one or more computers and/or mobile devices across a variety of computer networks, for example, the Internet and/or Intranet to provide to users the environments in various web browsers implemented on the one or more computers and/or mobile devices. Similarly, in various embodiments, the CERS Controller 12 may also be coupled to one or more databases across a variety of computer networks, for example, the Internet and/or Intranet to store user accounts and associated persistent data in the one or more databases. Additionally, the CERS Controller 12, may transmit, communicate, send, and/or output persistent data generated, calculated, stored, and/or computed by the CERS Controller 2 to one or more user environments on one or more computers or mobile devices. The CERS Controller 12, may also receive, communicate, and/or store persistent data that is inputted, entered, and/or populated in one or more user environments on one or more computers or mobile devices.

As discussed with various embodiments described herein, notifications and messages may be sent to various users or group of users within the CERS System 2. For example, a Corporate Manager 6 may send non-compliant messages or notifications to various logical groups within a company based on the Corporate Manager's 6 audit of continuing education requirements for a logical group within the company in the CERS System 2. However, if it is a single Professional 4 that is non-compliant, the corporate compliance manager may send messages via the CERS System 2 to only the single Professional 4. Likewise, the Corporate Manager may send notifications to professionals in only a division of the company in the CERS System 2. In a non-limiting exemplary embodiment, the Corporate Manager 6 may desire to send a message, via the CERS System 2, providing information about a class to the entire company informing all professionals within the company, that the company is sponsoring a class available to all professionals in the company. Alternatively, the Corporate Manager 6 may desire to send a message, via the CERS System 2, providing information about a class to the only a division of the company regarding availability of classes at the division's location. The and notifications messages in various embodiments described herein may be transmitted, sent, outputted, to various user environments on one or more computers and/or mobile devices. Additionally, the messages may be displayed in the news feeds, in the communications screen of respective dashboards of each user. Alternatively, the CERS System 2 may send emails the various users regarding the messages and notifications. As users send and receive messages and/or notifications, the CERS System 2 may update the users' accounts, which may include, but not limited to, storing and/or archiving the sent and received messages in users' accounts in the form of notifications data.

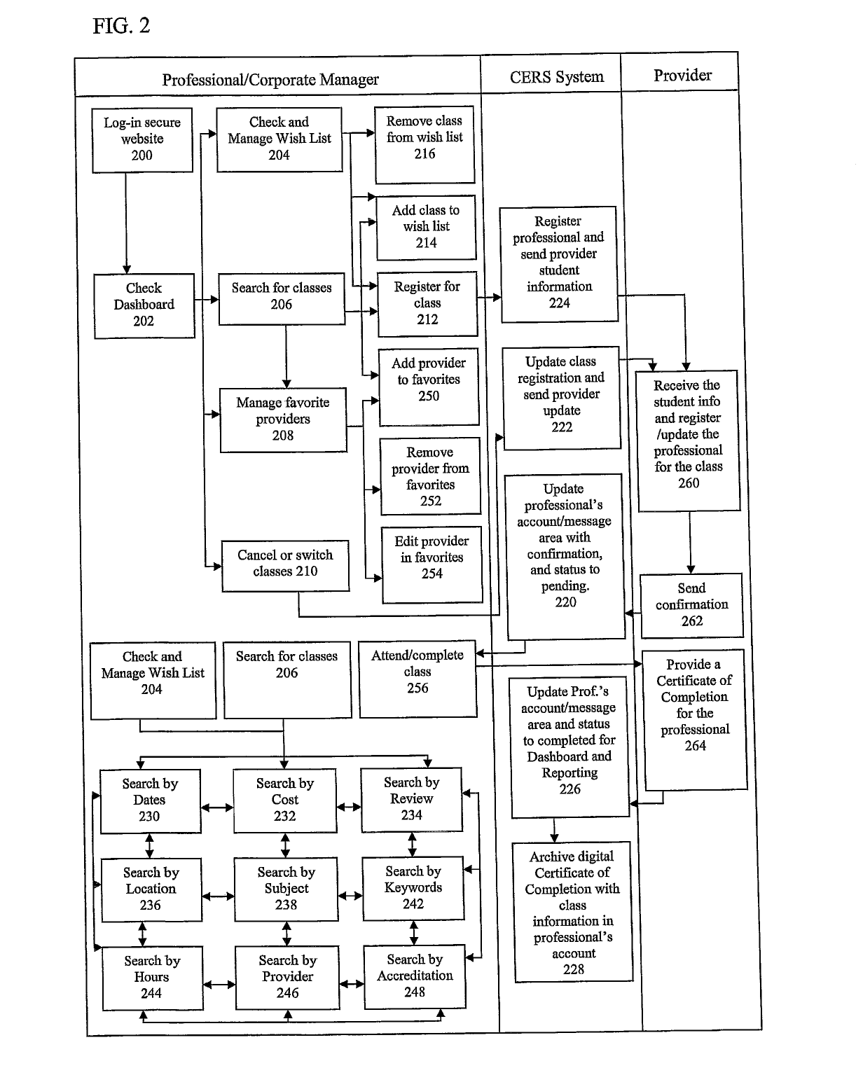

FIG. 2 is an embodiment depicting a logic flow for providing class registration to the Professional 4 or the Corporate Manager 6 for registration of a constituent, for example, Professional 4. Professionals such as Professional 4, who have continuing education requirements or corporate managers such as Corporate Manger 6, who may be responsible for professionals continuing education requirements may register with the CERS System 2 (step 200). As previously described, each user may also have an associated account in the CERS System 2, which may be stored in their respective databases such as the Professional Database 14, the Corporate Database 18, Licensing Database 32, and/or the Provider Database 22. The services provided by the CERS System 2 may be initiated by authenticating to a secure website provided by the CERS System 2_(step 200) using login information associated with the user's account for authentication of the user in the CERS System 2 and ensure the security and integrity of the transactions between the user and the CERS System 2. As mentioned previously, the login information may include, but not limited to, a user name and password or any other information that may be used to identify and authenticate the user in the CERS System 2. After the user is authenticated, CERS System 2 may provide status and continuing education requirements to the user by transmitting, communicating, sending, outputting, status data to one or more user environments on one or more computers or mobile devices so that users may check a dashboard to determine their current status and remaining continuing education requirements (step 202). The current status and remaining continuing education requirements information provided may vary depending upon whether the user is a Professional 4 using the Professional Environment 10, a Corporate Manager 6 using the Corporate Environment 16 or a Provider 8 using the Provider Environment 20 Licensing Body 34 using Licensing Environment 30. For example, a Professional 4 using the Professional Environment 10 may view status information that includes information relating to managing continuing education requirements illustrated in the exemplary embodiment of the user interface for the Professional Dashboard in FIG. 9a. The status screen may display, for example, number of continuing education credits received, total continuing education credits required, total remaining continuing education credits needed, and compliant information classes the Professional 4 is currently registered to attend (not shown in FIG. 9a). The compliance information may include information, such as whether the Professional 4 is currently compliant. Additionally, the current status information may be organized by subject, reporting period, and accreditation. The Professional 4 may also check CERS System 2 requirements for their past, present, and future continuing education. Alternatively, the current status information for the Corporate Manager 6 may include the information as illustrated in the exemplary embodiment of the user interface for the Corporate Dashboard in FIG. 9b.

In another embodiment of the logic flow in FIG. 2, the CERS System 2 may track continuing education needs of the Professional 4 by providing the ability to check and manage a wishlist (step 204) which may be associated with the Professional's 4 and the Corporate Manager's 6 account. The wishlist may provide a list or a collection of items, for example, a list of classes and/or providers selected by the Professional 4 or the Corporate Manager 6 on behalf of the Professional 4 to facilitate the Professional's 4 future needs. The wishlist operates like other CERS System 2 lists or collections described herein, meaning items, for example, classes, may be added to the wishlist (step 214), removed (step 216), or registered (step 212). With any operation performed in the wishlist by the Professional 4 via the Professional Environment 10, the CERS System 2 may update the wishlist data associated with the Corporate Manager's 6 and/or Professional's 4 accounts. The updates to the wishlist data may occur when the Corporate Manager 6 and/or the Professional 4 add classes to the wishlist (step 214), remove classes from the wishlist (step 216), or register for classes in the wishlist (step 212). If the Professional 4 or the Corporate Manger 6 chooses to add a class to the wishlist (step 214), the CERS System 2 may add class information and/or class identifier to the wishlist data associated with the Professional's 4 or the Corporate Manager's 6. If the Professional 4 or the Corporate Manger 6 chooses to remove a class from the wishlist (step 216), the CERS System 2 may remove the class information and/or class identifier from the wishlist data associated with the Professional's 4 or the Corporate Manager's 6 account. Finally, If the Professional 4 or the Corporate Manger 6 chooses to register a class in the wishlist (step 212), the CERS System 2 may register the class for the Professional 4 in the CERS System 2 (step 224) and remove the information relating to the registered class from the wishlist data associated with the Professional's 4 or the Corporate Manager's 6 account. The wishlist data may also be updated when the Provider 8 makes changes to the CERS System 2 which may affect users such as the Professional 4 or the Corporate Manager 6. For example, the Provider 8 may remove one or more classes available to Professional 4 or Corporate Manager 6 for registration. If the one or more removed classes are included in the Professional's 4 and/or the Corporate Manager's 6 wishlist, the CERS System 2 may update the wishlist data associated with the user's account and remove the unavailable class information and/or class identifier from the wishlist data and/or send a notice to Professional 4 and/or the Corporate Manager's 6 regarding the removed classes to their wishlist. The CERS System 2 may send the notice to a news feed (not shown) or messages section to the Professional Environment 10 or to the Corporate Environment 16 or it may be a separate mechanism for providing notices to the users of the CERS System 2 such as by e-mail. Favorite providers may also be used in CERS System 2 on both the wishlist and other processes described herein below.

In another embodiment of FIG. 2, the CERS System 2 may also track present needs of the Professional 4. Thus the Professional 4 may cancel (step 210) or switch classes previously registered (step 212). Any canceled or switched class may automatically update the class registration for the professional in the CERS System 2 (step 222) and provide notification to the corresponding one or more providers such as the Provider 8 regarding the canceled or switched class to update the professional for the class and ensure that the providers' systems are in sync with the CERS System 2 (step 260). In the case of a canceled class (step 222), the CERS System 2 may send an update to a provider providing the class, indicating that the professional has canceled the previously registered class. Alternatively, in the case of a switched class (step 222), CERS System 2 may send an update to a provider providing the class indicating that the professional has switched the previously registered class for a new class provided by the same provider. However, if the new class is not provided by the same provider as the previously registered class, the CERS System 2 may send an update to the provider providing the previously registered class indicating that the professional has canceled the previously registered class provided by the provider and register the professional for the new class provided by a corresponding provider.

In another embodiment of FIG. 2, the Professional 4 may also check their registered classes. CERS show a list of classes. The ERS System 2 may provide an interface to a class list having classes that were previously attended and classes that the Professional 4 can attend in the future to fulfill their continuing education requirements. The CERS System 2 may also provide to the Professional 4 via the Professional Environment 10 or the Corporate Manager 6 via the Corporate Environment 16 a list or collection of classes from a search conducted by the Professional 4 or the Corporate Manager 6 (step 206). If the Professional 4 decides to register for classes or the Corporate Manager 6 decides to register classes for the Professional 4 (step 212), the CERS System 2 may accumulate a list of classes for the Professional 4 or the Corporate Manager 6 chooses to register for. In one non-limiting exemplary embodiment, the CERS System 2 may provide a shopping cart/basket having a list of classes where the Professional 4 or the Corporate Manager 6 may add, remove or update the list of classes selected by the Professional 4 or the Corporate Manager 6 for registration. Additionally, the list of classes in the shopping cart may be saved, stored and/or archived as shopping cart data associated with user's account so that the users such as professionals and/or corporate managers may register and/or purchase the classes at a later time. Continuing with the embodiment of FIG. 2, if Professional 4 or Corporate Manager 6 chooses to continue to purchase or register the classes in the list of classes accumulated in the shopping cart, the CERS System 2 may receive the list of classes selected by the Professional 4 for registration and add the list of classes to be registered to the Professional's 4 account (step 224). In an exemplary embodiment of FIG. 2, additional registration information or data may be required if the Professional 4 decides to register for classes and payment information has not been previously entered. In that case, the CERS System 2 may prompt the Professional 4 to enter payment information before adding the list of classes to be registered to the Professional's account. However, if the class the Professional 4 is registering for or the Corporate Manager 6 is registering on behalf of the Professional 4 is already at maximum capacity, then the CERS System 2 may prompt the Professional 4 or the Corporate Manager 6 indicating that the class is full and in response to a request of Professional 4 or Corporate Manager 6, the CERS System 2 may add the class to the Professional's 4 or the Corporate Manager's 6 wishlist. After successful class registration, the CERS System 2 may send registration information or data to a corresponding provider that is managing and/or providing the associated classes for the Professional 4 to attend. The registration information or data may include, but not limited to, the class information, the Professional's 4 account information including payment information and/or any other information that may be necessary for a provider to properly manage and provide classes to professionals. In a non-limiting exemplary embodiment, the CERS System 2 may also enable the Administrative Assistant 26 and the Corporate Manager 6 to register, switch, or cancel a class for a plurality of professionals that may be linked to the Administrative Assistant's 26 or the Corporate Manager's 6 account. Additionally, providers such as Provider 8 may be a separate or an integrated entity, offering classes, seminars, instructors, or other planned activities and may arrange the classes separately from CERS System 2. It is to be understood that the arrangement of class services may take place in CERS System 2, in a different software module or in a separate software service.

In another embodiment of FIG. 2, CERS System 2 may receive student information regarding the Professional 4 from the Provider 8. The CERS System 2 may store the student information or data from the Provider 8 in the Professional's 4 account. For example, when a Professional 4 registers for a class, CERS System 2 may receive a confirmation message (step 220) sent by the Provider 8 (step 262). A confirmation message may include information or data indicating that the class has been successfully registered for. Alternatively, if the Professional 4 cancels or switches a class, confirmation messages may include information indicating that the class has been successfully canceled. The CERS System 2 may save the confirmation message into the Professional's 4 account (step 220). Additionally, the Professional's 4 account and/or pending messages for the Professional 4 may indicate that a confirmation message has been received from the Provider 8, and the status for the class may be updated to pending until attendance of the class (step 256). The completion of a class triggers the Provider 8 to provide the CERS System 2 a Certificate of Completion for the Professional 4 indicating that the professional has successfully completed the class (step 264). Alternatively, the Certificate of Completion may also be generated or created at the request of the Provider 8 by the CERS System 2 for continuing education credits received from classes offered by Provider 8. If, however, a class was canceled by the Professional 4 before completion of the class, the CERS System 2 may provide a notification to the corresponding Provider 8 providing the canceled class so that no certificate will be issued for the canceled class by the corresponding Provider 8. After a notification is sent back to CERS System 2 indicating that the class was completed (step 264), the CERS System 2 may update the Professional's 4 account indicating that the notification message was received from the Provider 8 (step 226). The notification message may include, but not limited to, the Certificate of Completion, class grade, class attendance and/or any other information indicating the completion of the class and/or the performance in the class by the Professional 4. The CERS System 2 may also update the Professional's 4 class completion status to reflect that the class the Professional 4 has taken has been completed. The update of the CERS System 2 may generate completion data which may include, but not limited to, adding the completed class credit hours to existing number of continuing education credits taken by the Professional 4 for the particular subject and update the current status of the Professional Dashboard and corresponding reports. After updating the Professional's 4 account, the CERS System 2 may archive the digital Certificate of Completion in the Professional's account (step 228) thereby, recording the Certificate of Completion as a part of the completed class stored in the professional's account.

In another embodiment of FIG. 2, the Professional Dashboard and the Corporate Dashboard may show current status and enable access to search functionality via a search screen provided to the Professional Environment 10, and/or the Corporate Environment 16 (step 206). Further, the CERS System 2 may also provide the search functionality to providers such as Provider 8. However, the search functionality for providers may be limited to only classes the provider has offered for registration by Professional 4 or Corporate Manager 6 within the CERS System 2. Using the search function, the Professional 4 may find classes provided by Provider 8 that fulfill some or all of their continuing education requirements. The search function (step 206) may provide different types of search fields to enable searches based on different types of criteria steps (230-248). A user of the CERS System 2 may also add or remove search fields associated with the different types of criteria. The CERS System 2 may, incrementally, with each addition of search fields enable a user to further limit their search results by searching for results matching more than one criterion and obtain a manageable list of classes to choose from. A search within the search function may be controlled by the input of keywords into a search field, the selection of one or more preset search criteria within a search field or the provided recommendations based on partial input into a search field. This, in turn, may generate one or more search queries in the CERS System 2. The CERS System 2 may provide the recommendations on a partial keyword input and automatically fill in a complete keyword in the search field based on the best match of the complete keyword to the existing partial keyword and the most popular searches within the CERS System 2. Implementations of the auto completion mechanism are well known in the arts. In a non-limiting exemplary embodiment, the auto complete functionality may query the CERS Controller 12 on each keystroke, and the CERS Controller 12 may in turn, match the partial keyword to the most popular searches within the CERS System 2 and generate auto complete data. In return, the CERS System 2 may transmit send, and/or communicate the auto complete data to the user environments to populate a list of sorted matches near the search field (by popularity and/or proximity to the existing partial keyword) for the user to select as the complete keyword. In another exemplary embodiment, the search screen may also provide a limiting set of requirements that must be met for a particular criterion. Moreover, the search screen may provide that the particular criterion must have at least one of the preset or user provided limitations. The search screen may also provide that the particular criterion must not have any of the preset or user provided limitations. Furthermore, the search may also provide that the particular criterion must have all the preset or user provided limitations. These additional requirements may be applied to one or more criteria to assist in further limiting and refining the search results for a user, such a Professional 4 or a Corporate Manager 6 to find classes.

In accordance with various embodiments of FIG. 2, the user may have a variety of criteria to narrow their search. In one embodiment, the user may search classes by dates, which is a search for classes within a date range (step 230). In another embodiment, the user may search by cost, which is a search for classes based on a specified cost or within a cost (step 232). In another embodiment, the user may search by review, which is a search for classes that have been reviewed by others (step 234). For example, the review may be a single score or a plurality of scores with an overall aggregate score indicating the impressions of professionals who have attended the class. Additionally, the review may contain actual comments about the class written by professionals and/or providers comments in response to professionals' comments. In another embodiment, the user may search by location which is a search for classes that are taught at a specified geographical, physical, and/or virtual (URI/URL) location (step 236). In another embodiment, the user may search by subject, which is a search for classes in a specified subject area (step 238). For example, business professionals may search for a particular area of business, including bankruptcy, tax accounting, or other subjects. In another embodiment, the user may search by keywords, which is a search for classes that matches searchable information associated with classes (step 242). In another embodiment, user may search by credit hours, which is a search of classes with a particular set number of hours or range of credit hours (step 244). For example, if two credits are needed to finish a requirement for ethics, CERS System 2 may match the credit hour requirement with one or more classes or can use this in combination, for example, with a subject search to provide one or more classes having two credit hours in a particular subject. In another embodiment, the user may search by provider, which retrieves an offering of classes offered only by one or more specific providers the Professional selected to retrieve offering of classes from (step 246). Additionally, one or more specific providers may be derived from the favorite providers list discussed herein and may be further narrowed based on certain subjects offered by providers, hours of classes, cost, and location of providers. In another embodiment, the user may search classes by accreditation based on one or more core competencies associated with a professional (step 248). For example, accreditation may include, but not limited to, doctors, attorneys, accountants, nurses, insurance agents, real estate agents, engineers, teachers and the like. In various embodiments, to provide the users with a list of classes, the CERS System 2 may match searchable fields in a database, such as Provider Database 22, with those of searched keywords or criteria. In response to a search, the CERS System 2 may transmit, send, communicate, and output, the list of classes in the form of search results data to one or more environments on one or more computers or mobile devices. It may be appreciated by those skilled in the art that providing users with a list of classes may be accomplished by any other means of searching in a database and returning the search result to the users.

In another embodiment of FIG. 2, the CERS System 2 may also automatically provide a recommendation of classes within the search results based on various characteristics unique to the Professional 4. The unique characteristics may include, but not limited to, the classes Professional's 4 have taken, the subject and type of classes the Professional 4 has provided positive feedback on, the Professional's 4 location, the average or median cost of the classes taken by Professional 4, and/or the Providers 8 of classes taken by the Professional's 4. The CERS System 2 may aggregate unique characteristics data from numerous professionals using collaborative filtering methods known to those skilled in the art and commonly used in recommendation systems to provide recommendations for a particular professional, for example, Professional 4. Additionally, the recommendations of classes may be further tailored to the Professional 4 based on the Professional's 4 current and remaining education requirements, their accreditation, the availability of the classes, and/or the location of the classes. Accordingly, the CERS System 2 may provide the recommendations by generating, creating, and/or building recommendation data including class identification data associated with one or more recommended classes based on a collaborative filtering method and transmit, send, and/or communicate the recommendation data to the user environments for display within the search results.

In another embodiment of FIG. 2, the CERS System 2 may provide management of the favorite providers list to both a Professional 4 and/or a Corporate Manager 6 (step 208). The favorite providers list may be created from either the search for classes screen (step 206) or manage favorite providers screen (step 208). Each class may provide a link, a button, or a widget selectable by a Professional 4 and/or Corporate Manager 6 to add the provider of the class as a favorite provider and store the favored provider in the favorite providers list (step 250). Professional 4 and/or Corporate Manger 6 may also remove providers from the favorite providers list (step 252), or edit list of providers (step 254). With any operation performed in the favorite providers list by the Professional 4 via the Professional Environment 10 or the Corporate Manager 6 via the Corporate Environment 16, the CERS System 2 may update the favorite provider list data associated with the Corporate Manager's 6 and/or Professional's 4 accounts. The updates to the favorite provider list data may occur when the Corporate Manager 6 and/or the Professional 4 add a favorite provider to the favorite provider list (step 250), remove a favorite provider from the favorite provider list (step 252) or edit provider in favorite list (step 254). If the Professional 4 or the Corporate Manger 6 chooses to add a provider to the favorite provider list (step 250), the CERS System 2 may add provider information or information identifying the provider to the favorite provider list data associated with the Professional's 4 or the Corporate Manager's 6 account. If the Professional 4 or the Corporate Manger 6 chooses to remove a provider from the favorite provider list (step 252), the CERS System 2 may remove the provider information or information identifying the provider from the favorite provider list data associated with the Professional's 4 or the Corporate Manager's 6 account. If the Professional 4 or the Corporate Manager 6 chooses to edit provider in favorites (step 254), the CERS System 2 may provide the favorite provider list where the Professional 4 or the Corporate Manager 6 may select on any particular provider to further narrow the returned search results derived from the favorite provider list. In one embodiment, the CERS System 2 may provide the Professional 4 or the Corporate Manager 6 the option to return a listing of classes from search results in accordance with only the class locations or subject the Professional 4 or the Corporate Manager 6 has selected for a particular provider. The favorite provider list data associated with the Professional's 4 or the Corporate Manager's 6 account may also be updated when the Provider 8 is no longer available. For example, CERS System 2 may remove one or more favorite providers that are no longer available in the provider network and send a notice to Professional 4 and/or the Corporate Manager's 6 regarding the removed favorite providers from their wishlist. The CERS System 2 may also send the notice to a news feed or a messages section in the status screen or the communications screen of the Professional Environment 10 or the Corporate Environment 16. Alternatively the CERS System 2 may send the notice via a separate mechanism such as by e-mail.

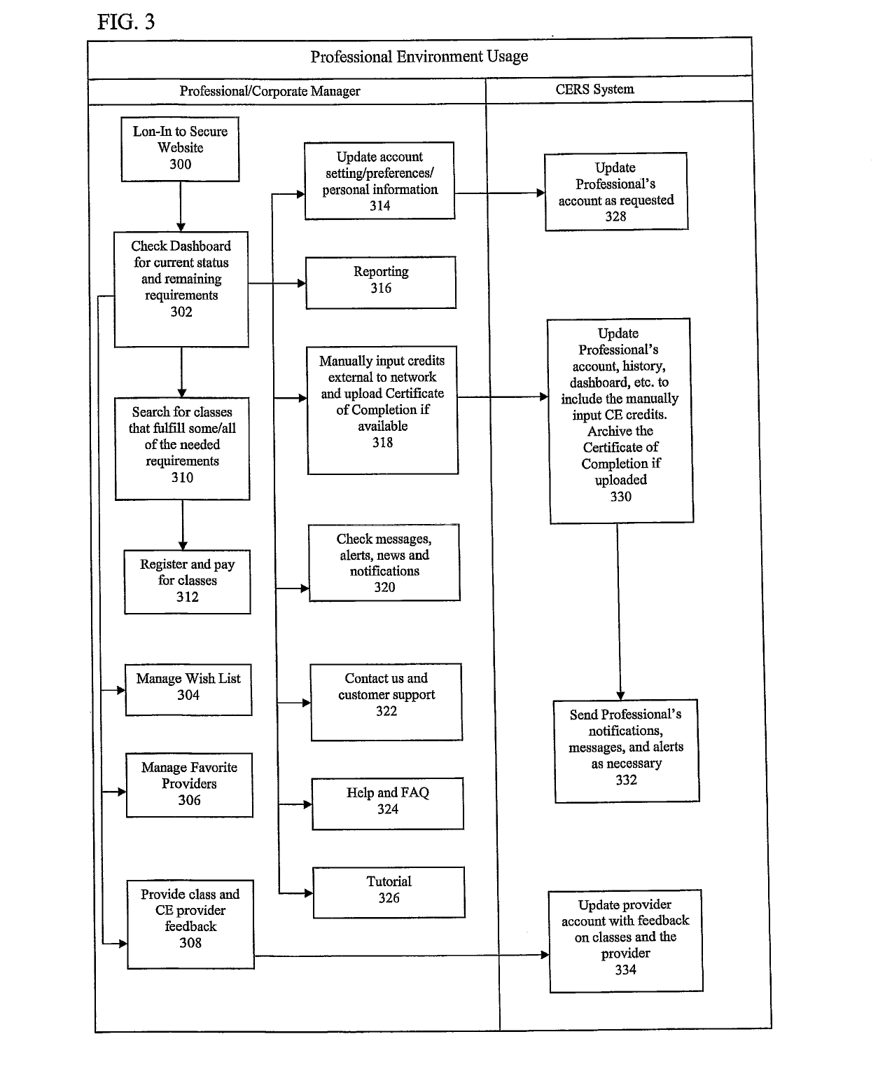

FIG. 3 illustrates an embodiment of the logic flow depicting the interactions between a Professional and the CERS System 2. In one embodiment, after the Professional 4 logs into the secure system using the Professional's 4 login information (step 300), the CERS System 2 may provide via the Professional Environment 10 a Professional Dashboard displaying the current status and the remaining requirements of the Professional's 4 continuing education requirements (step 302). Additionally, the CERS System 2 may provide the Professional 4 with functionality previously described such as, searching for classes (step 310) and registering for classes listed in search results (step 312) manage the wishlist (step 304), and manage the favorite providers list (step 306). The CERS System 2 may also enable the Professional 4 to provide class and continuing education provider feedback (step 308), update Professional's 4 account, setting, or preferences (step 314), manage reporting (step 316), manually enter continuing education credits (step 318), check messages (step 320), contact support (step 322), get help information and frequently asked questions (FAQ) (step 324), and review tutorials (step 326).

In an exemplary embodiment of updating the Professional's 4 account, settings or preferences in FIG. 3, the CERS System 2 may provide various selectable options within the user interface of the Professional Environment 10 to enable the Professional 4 to edit personal information such as name, address, phone number, login information, job status, and accreditation license numbers. The CERS System 2 may enable the Professional 4 to edit their credit card information for payment of classes. For example, the CERS System 2 may enable the Professional 4 to add payment methods by adding a new credit card used for payment, removing existing payment methods by removing an existing credit card for payment or editing the existing credit card information. The CERS System 2 may also enable the Professional 4 to manage their subscription to the CERS service and enable the Professional 4 to view their billing history, link and unlink personal and corporate accounts. For example, as the Professional's 4 join and leave a company, the Professional's account may be linked to Administrative Assistant's 26 account and/or Corporate Manager's 6 account so that the Administrative Assistant 26 or Corporate Manager 6 may perform management and tracking functions, for example, register classes on behalf or for the Professional 4. However, when the Professional 4 leaves the company then Professional's 4 account will be unlinked from the Corporate Manager 6's account and/or Administrative Assistant's 26 account and consequently, removing authority from the Corporate Manager 6 and/or Administrative Assistant 26 to perform tracking and management functions within the CERS System 2 for or on behalf of the Professional 4. The CERS System 2 may track the linked accounts by the use of a map, collection or list in the linked accounts data so that as accounts are linked, the map, collection or list within each account is added, removed or modified accordingly. The CERS System 2 may also enable the Professional 4 to manage their accreditations and jurisdictions. For example, CERS System 2 may enable the Professional 4 to add the Professional's 4 accreditation, the jurisdiction of the accreditation, and the license number associated with the accreditation into the Professional's 4 account. The CERS System 2 may also provide the Professional 4 with a list of existing accreditations which the Professional 4 has previously added that may be edited or deleted. Using the accreditation information and jurisdiction information provided by the Professional 4, the CERS System 2 may compare, calculate, and determine the current status and remaining continuing education requirements for all of the Professional's 4 accreditations across multiple jurisdictions. In one embodiment, the CERS System 2 may, based on requirements of a jurisdiction for a particular accreditation, determine whether the Professional 4 is currently compliant and the remaining requirements necessary to become compliant. For example, the CERS System 2 may compare the current requirements for the jurisdiction and accreditation with those stored within account of the Professional 4. If, for example, the Professional 4 does not meet continuing education requirements for the jurisdiction and accreditation, then the CERS System 2 may update the Professional's 4 current status as non-compliant and calculate the number of credits required to become compliant. Additionally, the information may be used by the CERS System 2 to determine which accreditation and jurisdiction the continuing education class credits may be applied to and update the Professional's 4 account information accordingly. The CERS System 2 may enable the Professional to edit management of subscription of news feeds which may be selected based on accreditation or jurisdiction. The news feeds may include information, such as headline news on new developments in the field or events in the jurisdiction. The CERS System 2 may also enable the Professional 4 to manage alerts sent to their communications dashboard or emails. For example, the CERS System 2 may enable the professional to modify the frequency of certain alerts and updates such as class registration/cancellation, class completion updates and certificate of completion posting, payment for purchased classes updates, wishlist/wait list updates, class status updates, approaching deadlines for classes, continuing education credit hour status, expiration of account, special class offerings, CERS System 2 updates and/or news. In an exemplary embodiment of updating the Professional's 4 account, the CERS System 2 may also enable the professional to manage the subscription to the services provided by the CERS System 2 such as renewing the subscription or starting a new subscription. In another exemplary embodiment of updating the Professional's 4 account, CERS System 2 may enable the Professional 4 to view the Professional's 4 account status, for example, list of unpaid classes. It may be appreciated by the person skilled in the arts, that the CERS System 2 may enable the Professional 4 to edit, modify, update, add, remove, the functionalities and options discussed in the above exemplary embodiment by providing various input fields selectable by the Professional 4 in the Professional Environment 10. To the extent that the Professional 4 changes or sets any account settings and/or preferences in the above exemplary embodiment, the CERS System 2 may receive any changes or additions and update the Professional's 4 account accordingly (step 328).

When a Professional 4 has taken a class not provided by Provider 8, CERS System 2 may accept continuing education credits received from classes provided by continuing education providers not within the network (step 318). Credits hours, class name, the provider of the class, the type of class, the date taken, the accreditation of the class, the jurisdiction of the class, and/or the reporting period may be manually entered for classes taken out of the system. If a Certificate of Completion is available, the Certificate of Completion may be uploaded (step 318) to the CERS System 2. The CERS System 2 may then receive the class information and the Certificate of Competition, if available, and automatically update the Professional 4's account to include the manually input class information archive the Certificate of Completion into the account of the Professional 4 (step 330). After successful update of the professional information, the CERS System 2 may send alert notifications to the Professional 4 via the communications screen or the messages section in the Professional Dashboard regarding the successful update of manually entered credits (step 332).

In another embodiment of FIG. 3, the CERS System 2 may accept class and provider feedback information from Professional 4 (step 308) which the Professional 4 may provide to the CERS System 2. CERS System 2 may provide a template having gather fields associated with a variety of questions for the Professional 4 to enter their response. Although feedback information may be provided in various forms, generally, they are reviews of classes and/or providers that can offer valuable insight from students' perspective regarding experiences the students had in attending the classes and/or the experiences of providers regarding administration of the classes. Feedback information may also provide insight to Provider 8 regarding their classes compared to providers providing similar classes. As described herein, when a professional takes a class, the information that can be captured consist of class information, instructor information, and provider information. Questions, such as “did you like the class,” “did you like the instructor,” “did you like the material presented,” “did you like the format of the class,” may be asked. After the feedback information is submitted to the CERS System 2, the System will update the provider's account with feedback information or data on the classes and/or feedback information or data on the provider themselves (step 334). The feedback information or data may be used to provide information to other professionals to help them decide whether they would like to attend a particular class. This information may also be used by Provider 8 to determine if the class or information relating to the class needs to be revised or used to plan other classes in the future. In one exemplary embodiment, the feedback information may be captured by using a scale, for example, a 1-5 rating for the instructor's performance in teaching the class, one being the lowest and five being the highest with controlled data that the system may use to inform its users. The ratings then become part of the CERS System 2 and may be transmitted, sent, communicated and/or outputted to one or more environments on one or more computers or mobile devices for display to the Professional 4, Corporate Manager 6 and Administrative Assistant 26 as they are browsing classes or any other places in the CERS System 2 where a rating would likely be needed by a Professional 4, Corporate Manager 6 or Administrative Assistant 26 for example, a search by an instructor. Another way to capture the feedback information is by the use of input fields for answering questions such that the student can provide a written response to the questions in conjunction with an overall scale rating for the class or scale ratings for particular aspects regarding the class. The CERS System 2 may provide the statistical information or data to Provider 8 so that the Provider 8 can study the trends and monitor the performance of their classes and in return, the Provider 8 may improve upon the offered classes, provide additional classes or eliminate classes that have consistently fell behind in reviews in accordance with the feedback information provided. Statistical information or data may include, but not limited to, a list of highest/lowest rated classes, a list of highest/lowest rated instructors, or a list of highest/lowest rated providers based on an aggregate rating of the classes a provider provides. Furthermore, the ratings may be tracked over a period of time to find trends with respect to the classes offered. For example, the trends may establish that the aggregate ratings for classes provided by a particular provider has consistently declined over the past 5 years or that classes associated with a particular topic has been consistently highly rated over the past 5 years. These trends may cause a provider to be eliminated from the provider network if they are consistently providing low rating classes. Additionally, these trends may assist Professional 4 and/or Corporate Manager 6 alike to determine what is popular and what is unpopular when placing their order for or purchasing a continuing educational class. Providers 8 can also use these trends to figure out what classes they should provide. The statistical information or data may be provided to the Provider 8 in the Provider Environment 20 as lists, data plots, graphs, and/or any other means to convey to the Provider 8 the statistical information data gathered by the CERS System 2. It may be appreciated by those skilled in the arts that exemplary uses and embodiments of the statistical information or data may not be limited in this context. For example, the statistical information or data may be used in the search functionality to provide suggestions to professionals based on what types of classes other professionals have attended and liked.

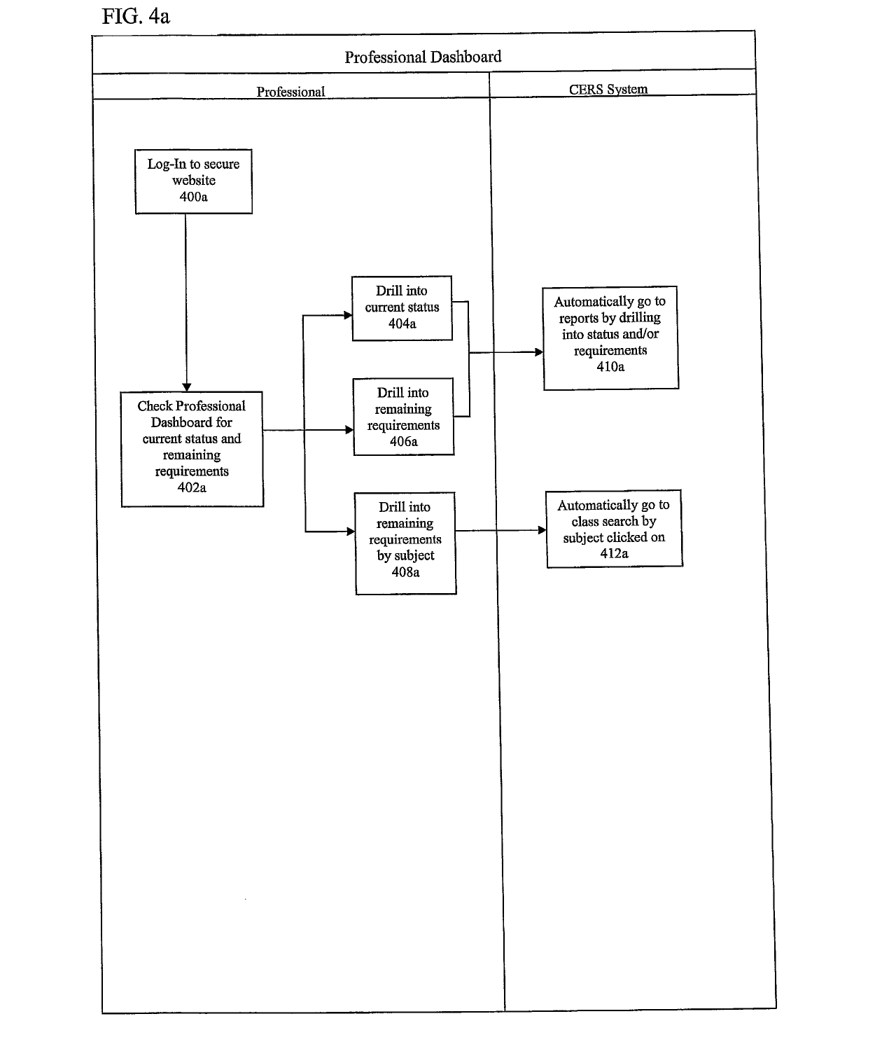

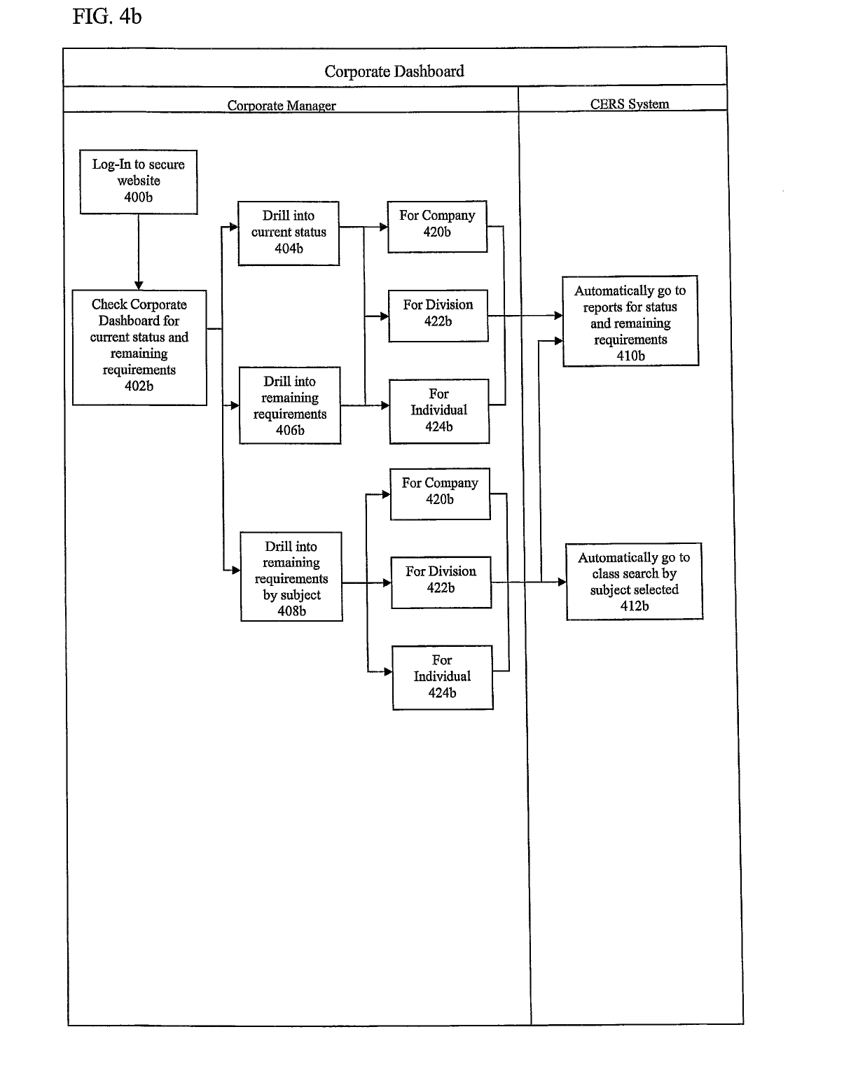

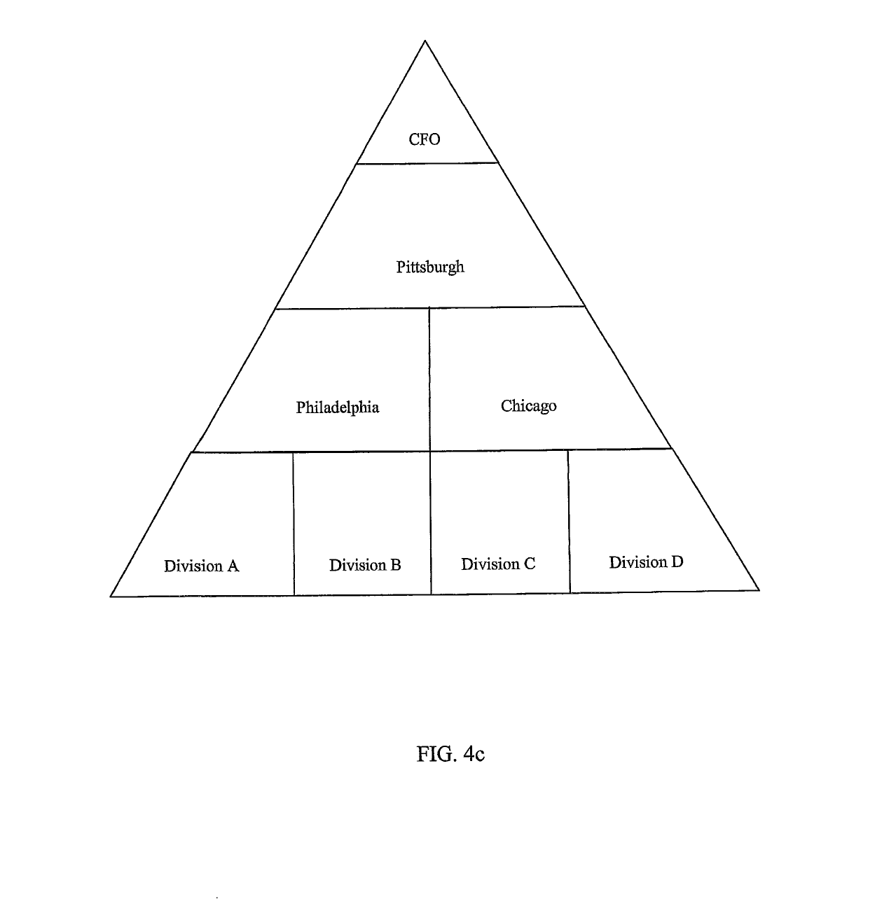

FIG. 4a illustrates an embodiment depicting the logic flow for controlling the Professional Dashboard. After the Professional 4 or Administrative Assistant 26 logs into the secure website using their login information (step 400a), the CERS System 2 may provide the Professional 4 or Administrative Assistant 26 with a dashboard to check their current status, view remaining requirements or view remaining requirements by subject (Step 402a). If the Professional 4 or Administrative Assistant 26 choose to view detailed information of current status (step 404a), or remaining requirements (step 406a), the CERS System 2 may automatically drill into the current status remaining requirements and provide reports of the current status and/or remaining requirements (step 410a). If the Professional 4 or Administrative Assistant 26 chooses to view the remaining requirements by subject (step 408a) and selects a particular subject, for example, by clicking, on that subject (step 408a), the CERS System 2 may automatically perform a class search (step 412a) based on the particular subject selected and output a list of available classes. Additionally, the Professional 4 or Administrative Assistant 26 may filter the search result by providing one or more search criterion previously described. CERS System 2 may also provide report of the current status, remaining requirements and/or the remaining requirements by subject within the Professional Environment 10.

FIG. 4b illustrates an embodiment depicting the logic flow of a Corporate Dashboard that provides the Corporate Manager 6 the capability to manage employees such as Professional's 4 continuing education requirements. In various embodiments, a Corporate Manager 6 is any person associated with the company who is tasked with the duty, among their other duties, of monitoring continuing education requirements of professionals within the company. Corporate Manager 6 serves an important function for companies because if professionals having continuing education requirements were found not to meet the requirements set forth by a licensing authority for a particular jurisdiction, the company may be held liable for lack of certification. Oftentimes large companies, in order to ensure all their employed professionals are in compliance, may have more than one corporate manager to manage the continuing education requirements of their professionals. For example, a company may have a human resources (HR) member dedicated to a specific region and a different HR member dedicated to a different region. These HR members could monitor the employees that are assigned to their own regions. HR member of one region could be in charge of continuing education for his/her region while another HR member could be in charge of continuing education of his/her region, each group having accountants with distinct job duties. The manager of the HR department may monitor the whole company and analyze the regions to see how a particular region is performing in terms of compliance with various continuing education requirements in various jurisdictions. Therefore, it is to be understood that although various embodiments refers to only a Corporate Manger 6, the CERS System 2 may provide the Corporate Environment 16 to one or more persons in the company who may have the duty to monitor professionals continuing education requirements. Further, depending upon company hierarchy and where the Corporate Manager 6 fits within the company hierarchy, their access to current status, remaining requirements, and remaining requirements by subject may also be further restricted which is described in detail with respect to the embodiment illustrated in FIG. 4c.

In one embodiment of FIG. 4b, after the Corporate Manager 6 logs into the secure website using their login information (step 400b), the CERS System 2 may provide the Corporate Dashboard to the Corporate Manager 6 (step 402b). The CERS System 2 may provide the current status (step 404b), the remaining requirements (step 406b), or view remaining requirements by subject (step 408b). If the Corporate Manager 6 chooses to view detailed information of current status, remaining requirements, or remaining requirements by subject, the Corporate Manager 6 may access the detailed information by drilling into the current status information (step 404b), the remaining requirements (step 406b), or the remaining requirements by subject (step 408b). If the Corporate Manager 6 chooses to view the remaining requirements by subject and selects a particular subject, for example, by selecting, clicking or drilling into a particular subject in the listing of subjects provided in the Corporate Environment 16 (step 408b), then the System will automatically perform a class search based on the subject selected and output a list of available classes (step 412b). The list of available classes may also be accompanied with feedback information associated with each available class and/or providers which are viewable by the Corporate Manager 6 to assist in their determination of whether a class is effective in satisfying the continuing education needs of professionals or whether a particular provider of classes should be avoided based on feedback information given by other professionals who have already taken the class. It may be appreciated that this is only but one example use of this information, as others would be apparent to those skilled in the art.

Additionally, the CERS System 2 may also aggregate the individual continuing education requirements at any level. Moreover, because the Corporate Manager 6 may be responsible for tracking numerous professionals' continuing education requirements throughout a company, the CERS System 2 may provide detailed information of the current status, remaining requirements, or remaining requirements by subject based on varying levels of the corporate structure. Accordingly, current status and remaining requirements may include composite or aggregated information that shows the continuing education requirements for professionals at various levels of a company. Continuing with the Embodiment illustrated in FIG. 4b, the CERS System 2 may provide current status and remaining requirements at the company level (step 420b), the division level (422b), or the individual level (424b). In one exemplary embodiment, when the Corporate Manager 6 chooses to view detailed information, by, for example, selecting and/or drilling into the current status for the company (step 420b), the CERS System 2 may automatically provide a report of the current status of all professionals in the entire company having continuing education requirements within the CERS System 2 (step 410b). The current status in this context may include, but not limited to, continuing education requirements of all professionals associated with the company, the overall company compliance with continuing education requirements, the subordinate offices compliance with continuing education requirements, the total credits for the company, the total remaining required credits, whether the company is compliant over all, the total required credits per class subject for the company, the total remaining required credits per class subject, and whether the company is compliant per class subject, the allowed, claimed and available number of credits per type of class or program for the entire company and/or any other information regarding their continuing education status. Continuing with the exemplary embodiment, if the Corporate Manager 6 chooses to view the remaining requirements by selecting and/or drilling into remaining requirements (step 406b) for the Company (step 420b), the CERS System 2 may automatically provide a report of the remaining requirements of all professionals in the entire company having continuing education requirements that is registered with the CERS System 2 (step 410b). The remaining requirements by company may include, but not limited to, the remaining or outstanding continuing education requirements of each professional before they are compliant and/or whether the professional is currently compliant. Additionally, the remaining requirements of all professionals may be displayed to the Corporate Manager 6 organized by specific subjects where each specific subject may be selected, clicked or drilled into by the Corporate Manager 6 (step 408b). Accordingly, if the Corporate Manager 6 chooses to view the remaining requirements by subject by selecting and/or drilling into remaining requirements by subject (step 408b) for the Company (step 420b), the CERS System 2 may automatically provide a report of the remaining requirements separated by class subject of all professional in the entire company having continuing education requirements with CERS System 2 (step 410b). Alternatively, the CERS System 2 may provide the current status (404b) or remaining requirements (406b) organized by division (step 422b) instead of by company (step 420b) where current status or remaining requirements of individual members or professionals of the division are shown. Accordingly, the current status by division may include, but not limited to, composite or aggregated information that shows the continuing education requirements for professionals within a division of the company. In another exemplary embodiment, the CERS System 2 may provide remaining requirements by subject (step 408b) organized by division (step 422b) instead of by company (step 420b) where remaining requirements by subject of the individual members or professionals of a division within the company are shown. As described above, if the Corporate Manager 6 chooses to view the remaining requirements by subject for a particular division and selects a particular subject, then the system will automatically perform a class search based on the subject selected and output a list of available classes (step 412b). These reports generated at the company level (step 420b) and division level (step 422b) may provide valuable insight on how continuing education requirements are met and what continuing education requirements are still outstanding either at the entire company or only a portion of the overall organization such as a division of the company. This will assist the Corporate Manager 6 to focus only on those divisions or professionals who may be falling behind in their continuing education requirements. These reports may also assist in logistical planning of the company, for example, assist a Corporate Manager 6 in determining whether it would be in the best interest of the company to schedule a class at the company site based on how many continuing education requirements for a particular subject has been met, how many are still required, and how many professionals are deficient in the particular subject. Accordingly, a Corporate Manager 6 may use this information to determine if it would be beneficial to schedule a class on the particular subject or subjects at the company site so that professionals may attend classes without having to leave the company premises or travel substantial distances from the company. The division separation may also allow companies to sort their employees in a logical order that reflects the actual company hierarchy. In a non-limiting exemplary embodiment, other information, such as historical data of past continuing education requirements at the company or division level may be shown. With respect to viewing the current status, remaining requirements and remaining requirements by subject for an individual (step 424b), the CERS System 2 may provide the Corporate Manager 6 a similar Dashboard to the Professional Dashboard, when the Corporate Manager 6 chooses or selects to view these requirements for an individual associated with the corporation such as Professional 4. Accordingly, the information available to the Professional 4 under the current status, the remaining requirements, and remaining requirements by subject as described with respect to FIG. 4a is also fully available Corporate Manager 6. After the CERS System 2 has provided the appropriate reports, the CERS System 2 may also automatically send reports at the request of the Corporate Manager 6 to other users such as Professional 4 to alert the users of their current status and/or continuing education requirements.

FIG. 4c illustrates an exemplary embodiment of access permissions for a Corporate Manager 6 based on logical separations within a company. The company may be logically separated into several logical groups. Accordingly, within the CERS System 2, the company may be separated by a regional office, followed by any offices reporting to the regional office or the subordinate offices, and each subordinate office may be further divided into divisions. At the top of the company hierarchy structure, an executive officer of the company may have access to all of the information in the company. In this exemplary embodiment, a chief financial officer (CFO) may be responsible for all of the employees in the company and can monitor all the constituents of the company. The regional office, such as the Pittsburgh Office is a second tier company in CERS System 2 and may include all of the employees in the company. The executive officer such as the CFO may have access to the Pittsburgh Office, in addition to any subsidiaries that is outside of the Pittsburgh Office. The corporate manager of the regional office or the regional corporate manager, for example, the HR manager, compliance manager, or the officer in charge of the company may view regional office constituents and offices that report to the regional office or the subordinate offices. In this exemplary embodiment, because the offices such as the Philadelphia Office and the Chicago Office reports to the Pittsburgh Office, the corporate manager of the Pittsburgh Office may not only view the Pittsburgh Office but also constituents of the Philadelphia and the Chicago Office. Additionally, constituents of any divisions of the offices reporting to the regional office may also be accessible to the regional corporate manager. However, corporate managers, in the offices reporting to the regional office may be restricted in access to only the regional office they are responsible for and any divisions within the regional office. For example, the Philadelphia Office may only have access to the company level information of constituents for Philadelphia and any divisions of the Philadelphia Office such as Division A and Division B. Similarly, the Chicago Office may only have access to the company level information of constituents for Chicago and any divisions of the Chicago Office such as Division C and Division D. Using the hierarchy structure defined by the pyramid model, the executive officer, such as the CFO, may enter the CERS System 2 at the highest level to determine whether the company is meeting its continuing education requirements. If the company is not, then the executive officer, such as the CFO, may refine the search to the level previously described. For instance, the executive officer, such as the CFO may determine, by looking at the subordinate offices such as the Philadelphia and Chicago Offices, whether or not they are in compliance. If a subordinate office, such as the Philadelphia Office, is in compliance and the Chicago Office is not, then the CFO may further investigate the Chicago Office. At this point, the executive officer, such as the CFO, may select or drill into the current status (step 404b), remaining requirements (step 406b) or remaining requirements by subject (step 408b) for Division (step 422b) and review the professionals employed at the divisions such as Division C and Division D of the Chicago Office and determine which divisions have constituents that are not in compliance. If, for example, the Chicago Office Division C has ten employees that are not compliant, then the CFO may respond to this information and devise a plan to remedy the situation. It may be appreciated by person skilled in the art that the types of logical groups are not limited to companies, subordinate offices and divisions as the CERS System 2 may be modified, as known to one skilled in the art, to encompass other types of groups meaningful to particular implementations.

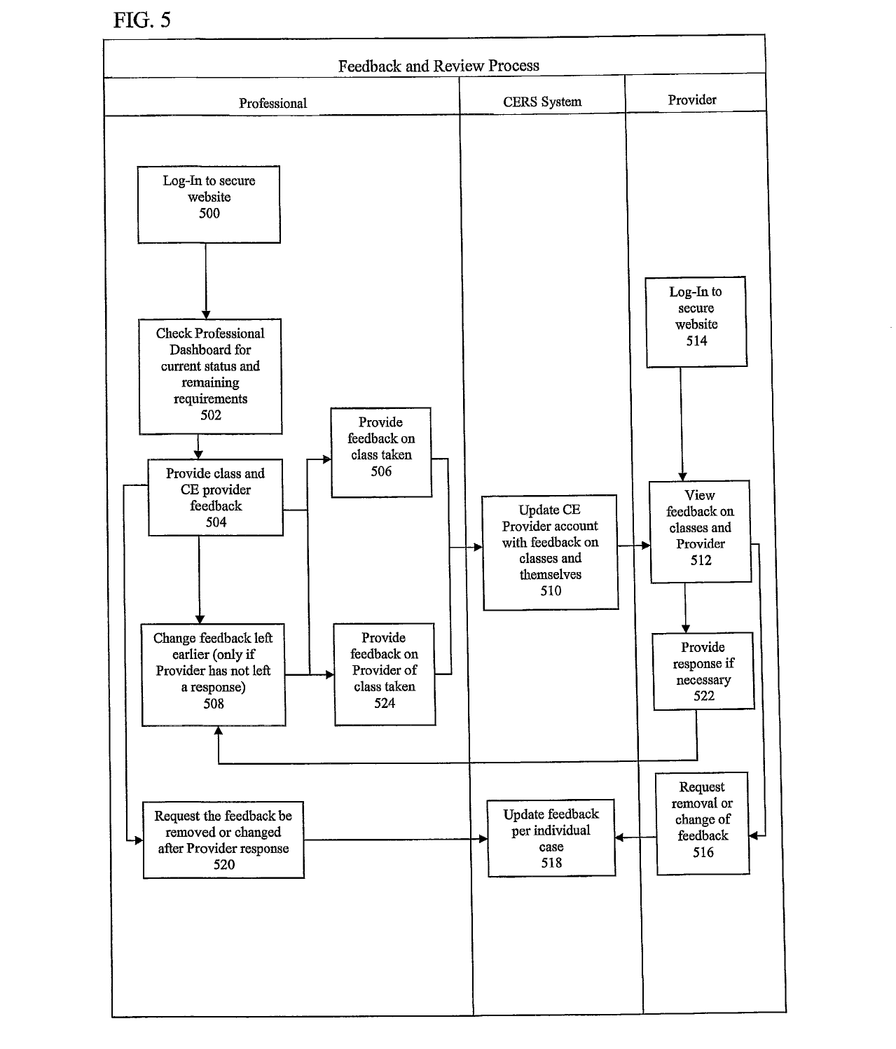

FIG. 5 illustrates an embodiment of a logic flow for providing and reviewing feedback information within the CERS System 2. The feedback and review process of the present invention begins when a Professional 4 logs into the secure website (step 500) and accesses the Professional Dashboard (step 502). As previously described, the feedback and review process may be used by the CERS System 2 to gather feedback information about the classes and/or providers the Professional 4 had experience with. The CERS System 2 may provide each Professional 4 the capability to input a review regarding a class the Professional 4 attended. The CERS System 2 may also provide the Professional 4 with capability of checking widgets, for example, one or more check boxes and/or radio buttons that can provide rating information for a particular class. The CERS System 2 may provide the Professional 4 with the option to choose to enter the feedback and review process from the Professional Dashboard (step 502). Moreover, the CERS System 2 may provide the Professional 4 the option to choose to provide class feedback about the class the Professional 4 attended (step 506) and/or provide feedback regarding the Provider 8 providing the class (step 524), which is distinguished from providing feedback only about the class (step 506). The CERS System 2 may also provide the Professional 4 with the option to change previously provided feedback (step 508) or flag feedback left by other professionals that were considered inappropriate which the CERS System 2 may automatically remove the flagged feedback after a certain number of flags by numerous professionals (not shown). However, if the Provider 8 providing the class has given a response to the feedback on the class, then the Professional 4 may no longer have the option to change the previously submitted feedback. CERS System 2 may also provide professionals or corporate managers the opportunity to send feedback information to the CERS System 2 about a Provider 8 who offered the class taken by the professionals. The feedback information may include, but not limited to, what the user liked about the way the provider ran the class, the administration of the class, the class location, and other feedback information that can be provided directly about the provider instead of only pertaining to the class. After the Professional 4 has entered and submitted the feedback information for a provider, CERS System 2 may receive the feedback information and update the account of the provider for which the feedback information was provided (step 510). The Provider's 8 account may include, but not limited to, information about the Provider 8 that the CERS System 2 uses to track individual providers such as a unique identifier as well as all the classes offered by the Provider 8. The CERS System 2 may update the provider's account by, for example, associating the feedback information with or adding the feedback information into the provider's account. Similarly, with respect to feedback information entered by the Professional 4 relating to classes, the CERS System 2 may update the feedback associated with the proper class in the appropriate Provider's 8 account by, for example, associating the feedback information with or adding the feedback information into the class provided by the corresponding provider. After the feedback information is updated within the CERS System 2, the CERS System 2 may provide notifications to the corresponding provider receiving the feedback regarding either a class provided by the provider or the provider themselves (step 510). Notifications within the CERS System 2 may take many forms as previously described. For example, the notification may be a message viewable in the Provider Environment 20 and may include, but not limited to, the feedback, the date and time the feedback was received or the user who left the feedback. Alternatively the feedback notifications may be sent via email by the CERS System 2 to Provider 8. The feedback information is given to the providers so they may act in accordance with the feedback information or provide a response to the feedback. Once the feedback information is stored or associated with the Provider's 8 account in the CERS System 2, the Provider 8 may log into the secure website of the CERS System 2 (step 514), which allows access to the Provider's 8 information. Similar to the Professional 4, the CERS System 2 may also enable the Provider 8 to navigate the CERS System 2 and view feedback information on the classes and themselves that has been gathered by the CERS System 2 and provided by the professionals who have already attended their classes, or corporate managers and professionals regarding their experience with the Provider 8 (step 512). If the Provider 8 so desires, the CERS System 2 may also enable the Provider 8 to send or leave a response to the feedback regarding a class they offered or feedback about the Provider 8 themselves (step 522). In addition, after the Provider 8 views the feedback about a class offered by Provider 8 or about themselves, the CERS System 2 may provide the Provider 8 the option to request the CERS System 2 to notify the Professional 4 to change or remove their feedback for the corresponding class provided by the Provider 8 or about the Provider 8 themselves (step 516). The update request notifies the CERS System 2 that the Provider 8 is requesting the feedback to be changed by the Professional 4 and that the CERS System 2 may also send a message to notify the corresponding Professional 4 regarding the request to change the feedback by the Provider 8. The Professional 4, after being notified that the provider has requested that a feedback left for a class or a provider needs to be changed, may either remove or change their feedback response (step 520) or leave the feedback as is. If the professional chooses to remove or change the feedback after the provider's response, the CERS System 2 may update the feedback (step 518) by either removing the feedback associated with the class in the Provider's 8 account or removing the feedback associated with the Provider 8 themselves in the Provider's 8 account. Alternatively, if Professional requested to change the feedback after the Provider's 8 response, the CERS System 2 may update the feedback by changing the existing feedback in accordance with Professional's 4 changes (step 518). Accordingly, if the Professional 4 has responded to the message by changing the existing feedback, the CERS System 2 may notify the Provider 8 regarding the updated feedback and changes the Professional 4 has made, and update the feedback information associated with the class or the Provider 8. If however, Professional 4 decided not to change feedback, and the Professional 4 has left numerous feedbacks regarding other classes and/or providers that are negative for an otherwise well received classes and/or providers, then the CERS System 2 may review the feedback on an individual basis and remove or modify the Professional's 4 feedback accordingly.

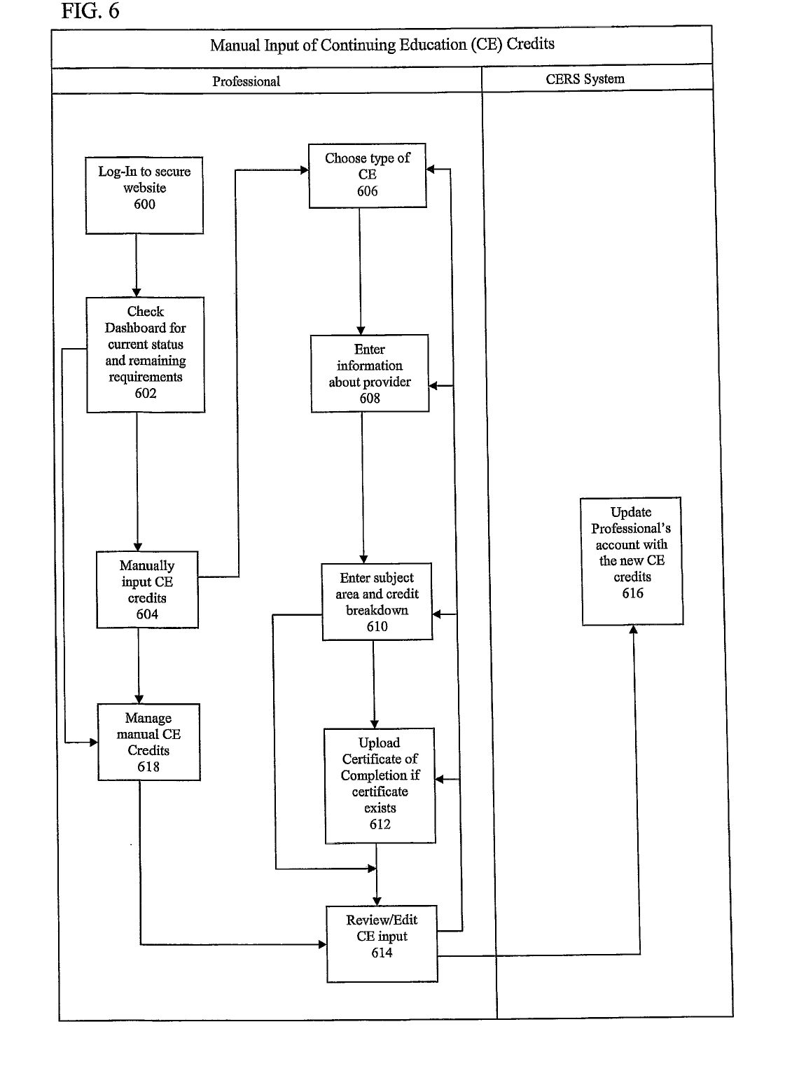

FIG. 6 illustrates an embodiment of a logic flow for entering certification information in the CERS System for class taken outside of the CERS System 2, which was described previously. In one embodiment of FIG. 6, after the Professional 4 logs into the system (step 600) and/or checks the Professional Dashboard for current status and remaining requirements (step 602), the CERS System 2 may provide the Professional 4, with the option of manually inputting a continuing education credits (step 604), after the Professional 4 completed a class from a provider not registered within the CERS System 2. If the Professional 4 desires to manually input a continuing education credit (step 604), CERS System 2 may provide the Professional 4 with the option to choose the type of continuing education credit (step 606), enter information about the continuing education provider (step 608) and enter the subject area and the credit breakdown (610) regarding what type of continuing education credits the Professional 4 has achieved external to the CERS System 2. If a Certificate of Completion has been provided by an external class provider, then the CERS System 2 may also provide the Professional 4 with the option to upload a Certificate of Completion that was provided to them by the external class provider (step 612). The information entered or submitted may be stored in the CERS System 2 to provide proof that the class external to the CERS System 2 was completed. The information may also be stored indefinitely or a period of time before it may be purged by the CERS System 2. The CERS System 2 may also provide the Professional 4 with the option to review and edit any continuing education input information (step 614) that was previously entered and not yet submitted by the Professional 4 before the continuing education input information is updated in the CERS System 2 (step 616). After the Professional 4 has reviewed or edited any changes to the continuing education input information and submitted the changes to the CERS System 2, the CERS System 2 may then update the Professional's 4 account with any additional or new continuing educational input information (step 616). Alternatively, CERS System 2 may also provide the Professional 4 the option to manually manage continuing education credits (step 618) for any classes and corresponding certificates that have already been manually placed into the CERS System 2. This enables the Professional 4 to modify and update any previously manually entered continuing education input information. In various embodiments discussed herein, the manual continuing education input information may include, but not limited to, credits hours, class name, the provider of the class, the type of class, the date taken, the accreditation of the class, the jurisdiction of the class, the reporting period, or addition and/or removal of previous mistakenly added credits or any other information to assist the CERS System 2 to track, add, remove, update, modify, manually input continuing education credits for classes taken by a Professional 4 outside of the CERS System 2.

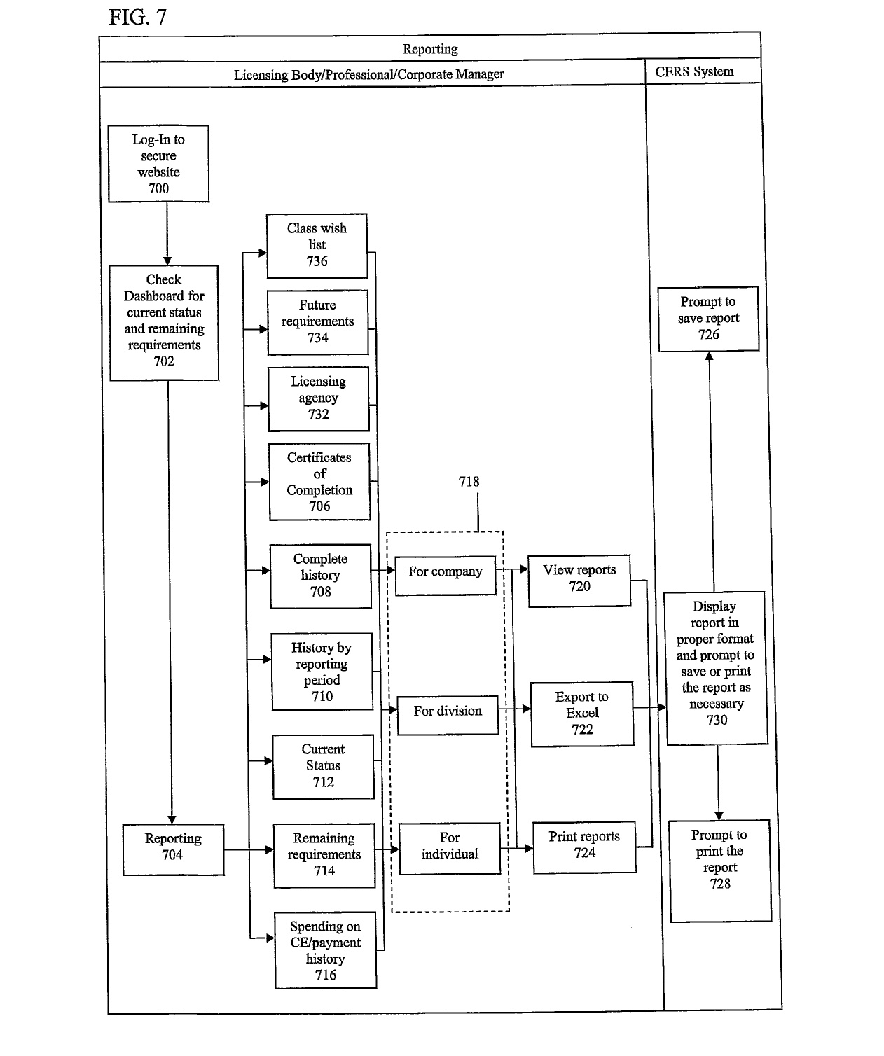

FIG. 7 illustrates an embodiment of a logic flow for obtaining reporting information from the CERS System 2. In one embodiment of FIG. 7, after the Professional 4 or Corporate Manager 6 logins into the secure website (step 700) and/or checks their respective dashboards for the current status (step 702), the Professional 4 or the Corporate Manager 6 may access the reporting functionality provided by the CERS System 2 (step 704). The CERS System 2 may provide access to the reporting functionality on the Professional or Corporate Dashboard (step 704) for example, as a selectable user interface widget or button. If the Professional 4 or the Corporate Manager 6 selects the reporting functionality (step 704), the CERS System 2 may provide the Professional 4 or the Corporate Manager 6 with a list of reports (steps 706-716, step 736 and step 734 if available) selectable by the Professional 4 or the Corporate Manager 6. The list of reports available to the Professional 4 and/or the Corporate Manager 6 includes, but not limited to, reports on Certificates of Completion (step 706), a complete history report (step 708), a history report by reporting period (step 710), current status report (step 712), remaining requirements (step 714), payment history report (716), future requirements report (step 734) if available, class wishlist report (step 736), continuing education cost report (not shown) and/or any other reporting feature that may provide information to the professionals about their continuing education requirements or to the corporate manager regarding their constituents continuing education requirements. However, it is to be understood that only a portion of the reports may be available to each user based on the access permissions data and/or linked accounts data of each user's account. Additionally, viewed reports may be printed, saved or exported into a computer readable format, for example, MICROSOFT® Excel spreadsheet template or comma-separated values (CSV) in a plain ASCII file format; it will be appreciated by the person skilled in the art that examples of computer readable format are not limited in this context. Further, with respect to the Corporate Manager 6, the CERS System 2 may further provide the reports filtered based on access permissions of the Corporate Manager 6 and his selection of the report level (illustrated by phantom element 718 of FIG. 7). Therefore, unlike Professional 4, the Corporate Manger 6 using the corporate view may not be limited to obtain reports only for a particular Professional's 4 account. Moreover, in corporate view, the CERS System 2 may provide the report to a Corporate Manager 6 that may be limited based on the Corporate Manager's 6 access permissions previously described with respect to FIG. 4c. In a non-limiting exemplary embodiment, the CERS System 2 may provide a Corporate Manager 6 at the subordinate office level reports of only those constituents or professionals within the subordinate office and the divisions within the subordinate office. However, the CERS System 2 may still provide Corporate Manger 6 at the subordinate office a report on the individual professional if the Corporate Manager 6 chooses. Alternatively, CERS System 2 may provide to an executive officer reports for all constituents or professionals employed by the company regardless of any intra-company logical groups.

In another embodiment of FIG. 7, after the Licensing Body 34 logins into the secure website (step 700) and/or checks their dashboards for the current status (step 702), Licensing Body 34 may access the reporting functionality provided by the CERS System 2 (step 704). The CERS System 2 may provide access to the reporting functionality on the Licensing Dashboard (step 704) for example, as a selectable user interface widget or button. If the Licensing Body 34 selects the reporting functionality (step 704), the CERS System 2 may provide the Licensing Body 34 with a list of reports (steps 706-714, 732 and 734) selectable by the Licensing Body 34. The list of reports available to the Licensing Body 34 includes, but not limited to, reports on Certificates of Completion (step 706), a complete history report (step 708), a history report by reporting period (step 710), current status report (step 712), remaining requirements (step 714), licensing agency report (step 732) and future requirements report (step 734), and/or any other reporting feature that may provide information to the Licensing Body 34 about the continuing education status of the professional or the continuing education status of a corporation. Additionally, viewed reports may be printed, saved or exported into a computer readable format, for example, MICROSOFT® Excel spreadsheet template or comma-separated values (CSV) in a plain ASCII file format; it will be appreciated by the person skilled in the art that examples of computer readable format are not limited in this context. Continuing with the Licensing Body 34, the CERS System 2 reports may include all professionals within a particular jurisdiction and accreditation governed by the Licensing Body 34. For example, a Licensing Board for law may audit all lawyers in a particular county or state in the CERS System 2 to ensure all lawyers practicing within that particular county or state are compliant.

In one embodiment of FIG. 7, the CERS System 2 may provide both the Licensing Body 34, Professional 4 and Corporate Manager 6 a report on Certificates of Completion for completed classes (step 706). For example, the report may provide the Professional with a complete list of Certificates of Completion for each class taken by the professional. Additionally, the CERS System 2 may format the report to be organized or sorted by jurisdiction, class subject, date, and the like. In another embodiment of FIG. 7, CERS System 2 may provide the Licensing Body 34, Professional 4 and the Corporate Manager 6 a report on the complete history of the classes taken by the Professional 4 (step 708). The CERS System 2 may also provide the report organized or sorted by class subject, jurisdiction and the like. In another embodiment of FIG. 7, the Licensing Body 34, Professional 4 and Corporate Manager 6 may also view the report on the complete hitory limited by a reporting period (step 710). Similar, to the Complete History report (708), History by Reporting Period (step 710), may also provide the report organized by class subject and jurisdiction. In another embodiment, the CERS System 2 may provide the Licensing Body 34, Professional 4 and the Corporate Manager 6 a report on the current status (step 712). In another embodiment, the CERS System 2 may provide the Licensing Body 34, Professional 4 and the Corporate Manager 6 reports regarding remaining requirements of the Professional 4 (step 714). In another embodiment, the CERS System 2 may provide the Licensing Body 34, Professional 4 and the Corporate Manager 6 reports regarding future requirements for the Professional 4 for the future reporting periods (step 734). In another embodiment, the CERS System 2 may provide the Professional 4 and the Corporate Manager 6 reports regarding spending information on continuing education and payment history (step 716). In another embodiment, the CERS System 2 may provide the Professional 4 and the Corporate Manager 6 reports regarding class wishlist of the Professional 4 (step 736). In another embodiment, the CERS System 2 may provide the Licensing Body 34 licensing agency reports regarding professionals with in a specific jurisdiction and accreditation (step 732). As previously described, with respect to Corporate Manager 6, any reports generated by CERS System 2 may include the reporting information either for the entire company or a division of subordinate office of the entire company based on the Corporate Manager's 6 access permissions and selection. Alternatively, the CERS System 2 may provide the Corporate Manager 6 reports only on a single individual professional based on the Corporate Manager's 6 access permissions and selection. In one embodiment, the CERS System 2 may also provide reports to the Licensing Body 34 across multiple companies within the jurisdiction and accreditation of the Licensing Body 34. Moreover, the report, for example, the current status report, which may include the compliance of continuing education requirements of professionals in the various companies or divisions within a company, may be limited to only professionals in companies or divisions of the company that is within the jurisdiction and accreditation of the Licensing Body 34. Accordingly, in one embodiment, access permissions for the Licensing Body 34 may enable the Licensing Body 34 to obtain current status report across multiple companies or restrict the current status to certain divisions within a company based on whether the company or portions of the company is within the jurisdiction or accreditation of the Licensing Body 34.

In another embodiment of FIG. 7, the CERS System 2 may provide the Licensing Body 34, Professional 4 or the Corporate Manager 6 the option to view the reports (step 720), export or download the reports (step 722) or print the report (step 724). As previously described, the report may be exported into a computer readable file format viewable as a spreadsheet in MICROSOFT® Excel, Comma-Separated Values in plain ASCII format or Portable Document Format (PDF). Furthermore, as previously described, the report may also be formatted for printing from the respective user environments such as the Professional Environment, the Corporate Environment, or the Licensing Environment (step 724). After the Licensing Body 34, Professional 4 or the Corporate Manager 6 selects to view report, print report or export the report, the CERS System 2 may, in response to the selection, receive report information indicating the type of report to be generated and displayed. If the report information indicates that the Licensing Body 34, Professional 4 or the Corporate Manager 6 selected to view the report, then the CERS System 2 may provide the selected report to the Licensing Environment 30, Professional Environment 10, or the Corporate Environment 16 respectively, for display in proper format (step 730). When the report is requested as a download or export, the CERS System 2 may prompt, for example, by the use of a save to dialog, the Licensing Body 34, the Professional 4 or Corporate Manager 6 the location to save the report ready to be downloaded or exported (step 726). When the report is requested to be printed (step 728), CERS System 2 may prompt, for example, by a message indicating the report is ready for print or opening a print dialog box, the Licensing Body 34, the Professional 4 or the Corporate Manager 6 to indicate that the prompt is ready to be printed.

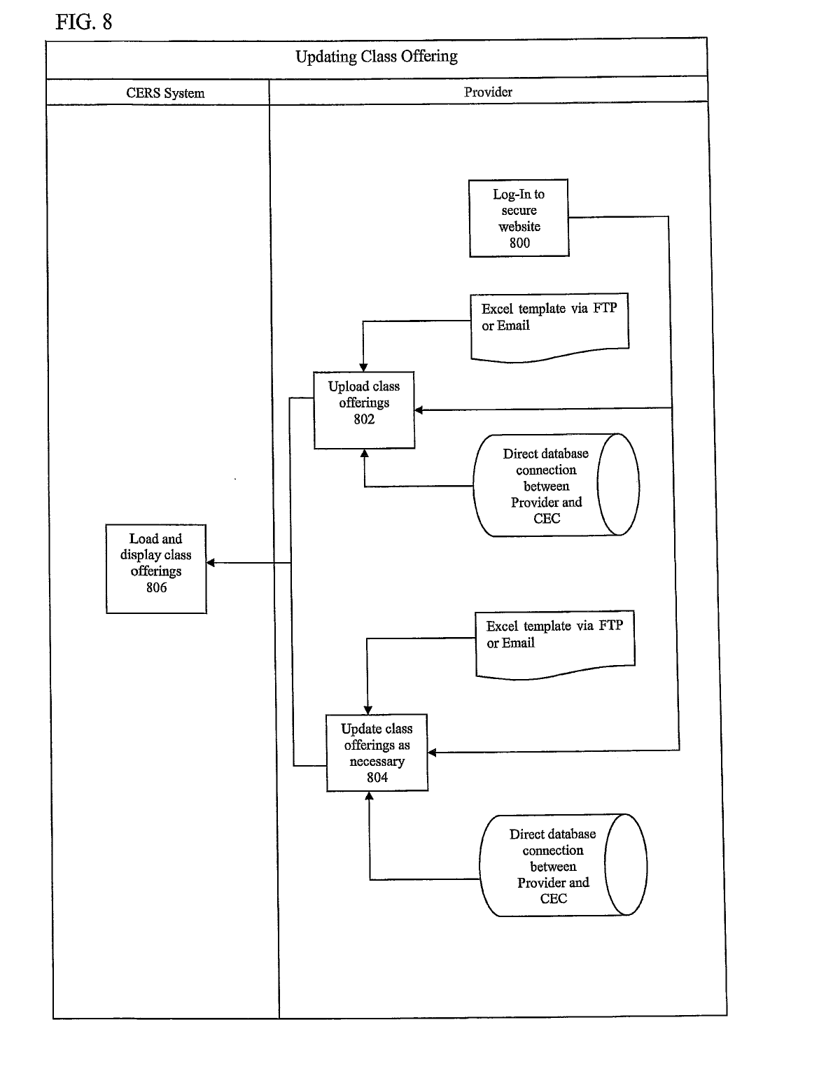

FIG. 8 illustrates an embodiment of a logic flow for updating classes within the CERS System 2. In one embodiment of FIG. 8, after the Provider 8 logs into the secure website using the Provider's 8 login information associated with Provider's account (step 800), the CERS System 2 may provide the Provider 8 the option of uploading class offering prepared by the Provider 8 for listing within the CERS System 2 (step 802) or updating existing class offerings already listed in the CERS System 2 (step 804). If Provider 8 chooses to upload class offerings to the CERS System 2 (step 802), data transfer of class offerings with associated class data in a computer readable file format must take place between CERS System 2 and Provider 8. Data transfer may include, for example, the use of any protocol supported by the web browser and/or external software for data transfer which may include, but not limited to, Hyper Text Transfer Protocol (HTTP), HTTP Secure (HTTPS), File Transfer Protocol (FTP), Secure-FTP (S-FTP), remote copy (RCP), secure copy (SCP) or E-mail. Alternatively, a database connection, either direct or indirect, may be used between the Provider 8 and the CERS System 2 to provide class listings to the CERS System 2. The computer readable file format may be in the form such as Microsoft Excel spreadsheet template which includes all of the relevant class information, such as title, time, location, instructor, credits, type of accreditation, jurisdictions, and any other information that would be necessary for the CERS System 2 to load and display the classes. Once the Provider 8 has selected to upload the class offering information, the CERS System 2 loads and/or indexes the class information and displays the class offering into class offering section of the CERS System 2 (step 806). Additionally, the class offering may now be searched and found by a Professional 4 or the Corporate Manager 6 in the search functionality previously described. After the classes have been loaded into the CERS System 2, CERS System 2 may enable the Provider 8 to update class information (step 804) when it is necessary for the Provider 8 to change information about the class. Similar to uploading class offering prepared by the Provider 8, class offerings may also be updated by a database connection, either directly or indirectly, between the Provider 8 and the CERS System 2, or through data transfer of a computer readable file format such as Microsoft Excel Spreadsheet template to the CERS System 2. The data transfer, as previously described, may include, for example, the use of any protocol supported by the web browser and/or external software such as HTTP, HTTPS, FTP, S-FTP, SCP RCP, E-mail, or any other data transfer mechanism available and known to one skilled in the art. Accordingly, this information may be uploaded from a mobile web browser implemented in a mobile device or other information points. Similar to new class offerings uploaded into the CERS System 2, the CERS System 2, after the updated class offering information is loaded, may provide the updated class offering information for display in the class offering of the CERS System 2 (step 806).

FIG. 9a, illustrates a user interface of the Professional Dashboard of the present invention. The user interface may includes a menu bar, with selectable or clickable widgets and/or buttons to links providing the Professional 4 information previously described such as information regarding the Professional's 4 account (“My Account”), viewing or tracking manual continuing education requirements (“Track Manual CE”) searching for classes (“Search Class”), search for providers (“Search Providers”), viewing and managing a wishlist (“Wishlist”), viewing and printing reports (“View/Print Reports”), invoke a tutorial of the CERS System 2 (“Tutorial”) and view the news (“News”). The Professional 4 may also view their continuing education requirements organized by accreditation, jurisdiction and/or subject. For example, the Professional 4 in FIG. 9a is a licensed practitioner in Accounting (element 904a) and in Law (element 914a). The reporting period for an accreditation such as Accounting (element 904a) of their continuing education requirement may be adapted to show any period that the Professional 4 would like to view. In addition, the Professional Dashboard user interface may also provide the total required credits, the individual's total, and the number of credits still needed, and a compliant field which can show whether or not the Professional is complaint or not for a particular jurisdiction. For example, FIG. 9a shows the Professional 4 is compliant only for tax and ethics, and still needs credits for auditing and other for a total of 42 needed to be compliant in the accounting jurisdiction (element 904a) of Illinois (element 906a). Although FIG. 9a illustrates the requirements by use of numbers, it may be appreciated that any other form of representation that is sufficient to notify the Professional 4 of his continuing education requirements may suffice. In one non-limiting exemplary embodiment not shown in FIG. 9a, the information regarding the total credit hours needed for various subjects may be displayed in a graph such as a bar graph where the bar fills in a solid color proportional to the number of credit hours Professional 4 has completed. Additionally, varying colors in the graph may indicate whether the Professional 4 is compliant. For example, a red colored bar that is partially filled may indicate the professional is non-compliant and missing continuing education credits. Other views may also be placed on the Professional Dashboard, for example, a news feed (element 908a) to allow the user to get news, for example, updates regarding continuing education requirements in various jurisdictions. Further, messages from the CERS System 2 or providers may be updated and/or populated in a messages box (element 910a) in the Professional Dashboard. The CERS System 2 may also provide information regarding the types of classes or program the Professional 4 may be allowed to take and may have already taken (element 912a). For example, CERS System 2, via the user interface, may provide a credit hours break down of the class or program types that may be available, for example, self study, authorship, or classroom programs. CERS System 2 may also keep track of the number of hours allowed and the number of hours claimed the number of hours available for each of these programs to achieve the continuing education requirements.

FIG. 9b, illustrates a Corporate Dashboard as the user interface for Corporate Manager 6 of the present invention. The user interface may includes a menu bar, with selectable or clickable widgets and/or buttons to links providing the Corporate Manager 6 to information previously described such as searching for classes (“Search Class”), search for providers (“Search Providers”), viewing and managing a wishlist (“Wishlist”), viewing and printing reports (“View/Print Reports”), communications with professionals (“Communications”), notifications (“Notifications”), invoke a tutorial of the CERS System 2 (“Tutorial”), organize corporate training for multiple constituents (“Organize Training”) and view the news (“News”). In this particular user interface, the Corporate Manager 6 is evaluating a Professional employed by the company (“Employee 1”) with the same traits as discussed hereinabove with regard to FIG. 9a. Additionally, the Corporate Dashboard may also provide status and remaining requirements information regarding other professionals (“Employee 2”) who is also employed by the company.

FIG. 9c illustrates a user interface for providing a certificate report to a Professional 4 or a Corporate Manager 6. As previously described, the CERS System 2 may provide report information that the Professional 4 or the Corporate Manger 6 has chosen to view. With respect to the certificate report for classes taken by professionals, the report information provided may include, but not limited to, the report options shown in element 904c, which is a navigation bar for navigating to other reports as previously described in detail. As described previously, the reports viewable, exportable or printable by professionals and corporate managers may include the complete history report, the history period, certificate report, payment history report, future requirements report, licensing agency report, and wishlists report. In an exemplary embodiment, the Certificate Report for professionals shown in FIG. 9c, which may include, but not limited to, information regarding date taken, location of the class, class name, provider, type, cost, credit hours, accreditation, jurisdiction, reporting period, and certificate. The user interface also provides a print button (element 906c) for printing the report and export buttons (element 908c) for exporting, downloading or saving the report in specific computer readable file formats such as MICROSOFT® Excel spreadsheet template, PDF or CSV (element 910c).

FIG. 9d illustrates a user interface that allows the user such as Professional 4 to log in and choose their accreditations and jurisdictions. The user interface widgets (elements 930d) and 932d) give the user the ability to change their accreditation, for example, from accounting to law or any other accreditation that they wish to choose. In addition, user interface (element 932d) allows the user to choose what jurisdiction within the accreditation they are licensed in. For example, Professional 4 may select accounting as their accreditation then followed by selecting the appropriate jurisdictions they are licensed in, for example, IL, NY, or any other jurisdictions. Professional 4 may select multiple jurisdictions under each specific accreditation. Accordingly, a user such as Professional 4 who is a licensed accountant (CPA) in NY, IL, CA, MI, and who is also a licensed attorney in NY and FL would be able to select all of the accreditations and jurisdictions and CERS System 2 may track all of the compliance for each jurisdiction and accreditation for that user.

Unless specifically stated otherwise, it may be appreciated that terms such as “processing,” “computing,” “calculating,” “determining,” “providing,” “updating” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. It also can be appreciated that while a logic flow may illustrate a certain sequence of steps, other sequences of steps may also be performed according to alternative embodiments. Moreover, some individual steps of a logic flow may include multiple sub-steps that may be performed in various sequences as appropriate to the individual step. Furthermore, additional steps may be added or some steps may be removed depending on the particular implementation.

In addition, the logic flow may be implemented by a hardware element, a software element executed by a computer, a firmware element embedded in hardware, or any combination thereof. In various embodiments, the logic flow may comprise, or be implemented as, executable computer program instructions. The executable computer program instructions may be implemented by software, firmware, a module, an application, a program, a widget, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language in accordance with the described embodiments.

In various embodiments, a logic flow may comprise, or be implemented as, executable computer program instructions stored in an article of manufacture and/or computer-readable storage medium. The article and/or computer-readable storage medium may store executable computer program instructions that, when executed by a computer, cause the computer to perforin methods and/or operations in accordance with the described embodiments. The article and/or computer-readable storage medium may be implemented by various systems and/or devices in accordance with the described embodiments. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Additionally, the article and/or computer-readable storage medium may be of the non-transitory type. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

In various embodiments, the account associated with each user, for example, the Professional 4, the Corporate Manager 6, the Provider 8, the Administrative Assistant 26, and the Licensing Body 34 may be stored within computer-readable storage medium and/or organized in one or more databases. The process of “updating” and/or “modifying” the accounts associated with various users described in various embodiments may include reading, writing, and/or modifying the account information and/or associated persistent data stored within the computer-readable storage medium that may be organized into one or more databases. Additionally, any persistent data described herein that may be associated with various user accounts or within various user accounts may also be stored in one or more databases.

In various embodiments, the present invention or portions of the present invention, for example, CERS System 2 may be implemented on a variety of computing devices and systems, wherein these computing devices include the appropriate processing mechanisms and computer-readable storage medium for storing and executing computer-readable instructions, such as programming instructions, code, and the like. For example, CERS Controller 2 may be implemented in a web server running one or more processes, for example, web server applications, to respond to various requests, for example, HTTPS, HTTP and/or FTP, from remote browsers on computers, such as computer 1344 of FIG. 10. Through HTTP, the exchange system may provide the user interface graphics to various embodiments. As shown in FIG. 10, personal computers 1300, 1344, in a computing system environment 1302 are provided. This computing system environment 1302 may include, but not limited to, at least one computer 1300 having certain components for appropriate operation, execution of code, and creation and communication of data. For example, the computer 1300 includes a processing unit 1304 (typically referred to as a central processing unit or CPU) that serves to execute computer-based instructions received in the appropriate data form and format. Further, this processing unit 1304 may be in the form of multiple processors executing code in series, in parallel, or in any other manner for appropriate implementation of the computer-based instructions.

In order to facilitate appropriate data communication and processing information between the various components of the computer 1300, a system bus 1306 is utilized. The system bus 1306 may be any of several types of bus structures, including a memory bus or memory controller, a peripheral bus, or a local bus using any of a variety of bus architectures. In particular, the system bus 1306 facilitates data and information communication between the various components (whether internal or external to the computer 1300) through a variety of interfaces, as discussed hereinafter.

The computer 1300 may include a variety of discrete computer-readable media components. For example, this computer-readable media may include any media that can be accessed by the computer 1300, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 1300. Further, this computer-readable storage medium may include communications media, such as computer-readable instructions, data structures, program modules, or other data in a modulated data signal, such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 1300 may further include a system memory 1308 with computer storage media in the form of volatile and non-volatile memory, such as ROM and RAM. A basic input/output system (BIOS) with appropriate computer-based routines assists in transferring information between components within the computer 1300 and is normally stored in ROM. The RAM portion of the system memory 1308 typically contains data and program modules that are immediately accessible to or presently being operated on by processing unit 1304, e.g., an operating system, application programming interfaces, application programs, program modules, program data and other instruction-based computer-readable codes.

With continued reference to FIG. 10, the computer 1300 may also include other removable or non-removable, volatile or non-volatile computer storage media products. For example, the computer 1300 may include a non-removable memory interface 1310 that communicates with and controls a hard disk drive 1312, i.e., a non-removable, non-volatile magnetic medium; and a removable, non-volatile memory interface 1314 that communicates with and controls a magnetic disk drive unit 1316 (which reads from and writes to a removable, non-volatile magnetic disk 1318), an optical disk drive unit 1320 (which reads from and writes to a removable, non-volatile optical disk 1322, such as a CD ROM), a Universal Serial Bus (USB) port 1321 for use in connection with a removable memory card, etc. However, it is envisioned that other removable or non-removable, volatile or non-volatile computer storage media can be used in the exemplary computing system environment 1300, including, but not limited to, magnetic tape cassettes, DVDs, digital video tape, solid state RAM, solid state ROM, etc. These various removable or non-removable, volatile or non-volatile magnetic media are in communication with the processing unit 1304 and other components of the computer 1300 via the system bus 1306. The drives and their associated computer storage media discussed above and illustrated in FIG. 13 provide storage of operating systems, computer-readable instructions, application programs, data structures, program modules, program data and other instruction-based computer-readable code for the computer 1300 (whether duplicative or not of this information and data in the system memory 1308).

A user may enter commands, information, and data into the computer 1300 through certain attachable or operable input devices, such as a keyboard 1324, a mouse 1326, etc., via a user input interface 1328. Of course, a variety of such input devices may be utilized, e.g., a microphone, a trackball, a joystick, a touchpad, a touch-screen, a scanner, etc., including any arrangement that facilitates the input of data, and information to the computer 1300 from an outside source. As discussed, these and other input devices are often connected to the processing unit 1304 through the user input interface 1328 coupled to the system bus 1306, but may be connected by other interface and bus structures, such as a parallel port, game port, or a universal serial bus (USB). Still further, data and information can be presented or provided to a user in an intelligible form or format through certain output devices, such as a monitor 1330 (to visually display this information and data in electronic form), a printer 1332 (to physically display this information and data in print form), a speaker 1334 (to audibly present this information and data in audible form), etc. All of these devices are in communication with the computer 1300 through an output interface 1336 coupled to the system bus 1306. It is envisioned that any such peripheral output devices be used to provide information and data to the user.

The computer 1300 may operate in a network environment 1338 through the use of a communications device 1340, which is integral to the computer or remote therefrom. This communications device 1340 is operable by and in communication to the other components of the computer 1300 through a communications interface 1342. Using such an arrangement, the computer 1300 may connect with or otherwise communicate with one or more remote computers, such as a remote computer 1344, which may be a personal computer, a server, a router, a network personal computer, a peer device, or other common network nodes, and typically includes many or all of the components described above in connection with the computer 1300. Using appropriate communication devices 1340, e.g., a modem, a network interface or adapter, etc., the computer 1300 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 1300, 1344 may be used.

As used herein, the computer 1300 includes or is operable to execute appropriate custom-designed or conventional software to perform and implement the processing steps of the method and system of the present invention, thereby, forming a specialized and particular computing system. Accordingly, the presently-invented method and system may include one or more computers 1300 or similar computing devices having a computer-readable storage medium capable of storing computer-readable program code or instructions that cause the processing unit 1302 to execute, configure or otherwise implement the methods, processes, and transformational data manipulations discussed hereinafter in connection with the present invention. Still further, the computer 1300 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Computer 1344 represents one or more work stations appearing outside the local network which may include one or more user computers providing one or more user environments. The one or more users interact with computer 1300, which can be an exchange system of logically integrated components including a database server and web server. In addition, secure exchange of information or data can take place through the Internet using secure world wide web. An e-mail server can reside on system computer 1300 or a component thereof. Electronic data interchanges can be transacted through networks connecting computer 1300 and computer 1344.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

The invention claimed is:

1. A continuing education registration and search (CERS) system, comprising:
at least one web server having a processor adapted to execute computer executable modules and a memory coupled to the processor, the at least one web server configured to communicate with at least one user computer via at least one user computer network, wherein the memory comprises at least one computer executable module, which, when executed by the processor, cause the processor to:
transmit data to the at least one user computer configured to generate at least one of a plurality of user interfaces, the plurality of user interfaces comprising a professional interface, a corporate interface, a licensing body interface, and/or a provider interface;
build at least one account associated with at least one user;
store at least one class associated with at least one attribute based at least partially upon data received from at least one user computer;
transmit search result data to the at least one user computer at least partially based upon at least one received search query from the at least one user computer;
transmit recommendation data, including class identification data, to the at least one user computer based at least partially on the result data;
generate registration data for at least one user at least partially based upon at least one received class selection from the at least one user computer;
generate completion data for at least one user at least partially based upon at least one received notification from the at least one user computer; and
transmit status data for the at least one user to the at least one user computer.

2. The system of claim 1, wherein the memory further comprises computer executable modules, which, when executed by the processor causes the processor to:
update a favorite providers list in at least one user interface of the plurality of user interfaces as the at least one user modifies at least one provider in the favorite providers list; and
update a class wishlist in at least one user interface as the at least one user modifies at least one class in the class wishlist.

3. The system of claim 1, wherein the memory further comprises computer executable modules, which, when executed by the processor, causes the processor to:
generate status data of the at least one user based on the current requirements of the jurisdiction and accreditation of the licensing body and persistent data of the at least one user; and
transmit at least one notification to at least one user computer to notify continuing education requirements of the at least one user.

4. The system of claim 1, wherein the memory further comprises computer executable modules, which, when executed by the processor, causes the processor to:
transmit feedback data associated with the at least one class and at least one provider to the at least one user computer;
receive feedback data for a class of the at least one class and a provider for the at least one provider from the at least one user computer;
generate statistical data at least partially based on the feedback data associated with each class and each provider; and
output the statistical data to the provider interface for a provider.

5. The system of claim 1, wherein the memory further comprises computer executable modules, which, when executed by the processor, causes the processor to:
enable an administrative assistant to register the at least one class for at least one professional based on access permissions data; and
enable a corporate manager to register the at least one class for the at least one professional based on linked accounts data.

6. The system of claim 1, wherein the memory further comprises computer executable modules, which, when executed by the processor, causes the processor to:
link a corporate manager account to at least one professional account to enable the corporate manager to register the at least one class for the at least one professional; and
link an administrative assistant account to at least one professional account to enable the administrative assistant to register the at least one class for the at least one professional based on access permissions data for each professional.

7. The system of claim 1, wherein the memory further comprises computer executable modules, which, when executed by the processor causes the processor to:
transmit class wishlist data to the at least one user computer for display to the at least one user;
update the class wishlist data associated with an account of the at least one user in response to a modification to a class wishlist by the at least one user; and
update the class wishlist data associated with the account of the at least one user when a class registered by the at least one user is already full.

8. The system of claim 1, wherein the memory further comprises computer executable modules, which, when executed by the processor, causes the processor to:
transmit favorite provider list data to the at least one user computer for display to the at least one user; and
update the favorite provider list data associated with an account of at least one user in response to a modification of a favorite provider list by the at least one user.

9. The system of claim 1, wherein the memory further comprises computer executable modules, which, when executed by the processor, causes the processor to:
store continuing education credit information based at least partially upon data received from the at least one user for credits received by an external provider, the continuing education credit information including credits hours, class name, provider of the class, type of class, date of class, the accreditation of the class, jurisdiction of the class, and/or reporting period.

10. The system of claim 1, wherein the memory further comprises computer executable modules, which, when executed by the processor, causes the processor to:
transmit the status data for at least one user to at least one user computer based on linked accounts data.

11. The system of claim 1, wherein the memory further comprises computer executable modules, which, when executed by the processor, causes the processor to:
transmit the status data for at least one user to at least one user computer based on access permissions data associated with an account of the at least one user; and
generate at least one report at least partially based on the access permissions data associated with the account of the at least one user.

12. The system of claim 1, wherein the memory further comprises computer executable modules, which, when executed by the processor, causes the processor to:
transmit the status data for a plurality of users to the licensing interface on at least one user computer for audit based on access permissions of the licensing body, wherein at least two users of the plurality of users are associated with different companies.

13. The system of claim 1, wherein the memory further comprises computer executable modules, which, when executed by the processor, causes the processor to:
update an account associated with a corporate manager as the corporate manager registers, switches, and/or cancels at least one professional for a class, manages a class wishlist associated with the corporate manager account, manages a favorite providers list associated with the corporate manager account, and/or provides feedback information;
update an account associated with a professional as the professional registers, switches, and/or cancels a class, manages a class wishlist associated with the professional account, manages a favorite providers list associated with the professional account, provides feedback information, and/or completes a class
update an account associated with a licensing body as the licensing body transmits notifications, updates rules and/or regulations, and/or audits professionals;
update an account associated with an administrative assistant as the administrative assistant links with the professional account; and
update an account associated with a provider as the provider uploads class offerings, updates class offerings, and/or receives and responds to feedback.

14. The system of claim 1, wherein the at least one received search query comprises at least one search criteria and the at least one search criteria is a search by date, search by cost, search by review, search by location, search by subject, search by keywords, search by hours, search by provider, and/or search by accreditation.

15. The system of claim 1, wherein the at least one attribute includes, location, class name, provider name, instructor name, cost, accreditation, credit hours, and/or feedback information.

16. The system of claim 11, wherein a report in the at least one report is a certificates of completion, complete history, history by period, current status, remaining requirements, future requirements, class wishlist, licensing agency, and/or payment history.

17. The system of claim 1, wherein each account of the at least one account is associated with persistent data comprising rules and regulations data, notifications data, shopping cart data, class data including class identification data, status data, registration data, recommendation data, search result data, wishlist data, favorite provider list data, access permission data, registered classes, login information, completed classes, accreditation and license number, personal messages, linked accounts data, notifications, payment information, first name and last name, phone number, address, zip code, and/or email address.

18. The system of claim 1, wherein the status data comprises a number of continuing education credits received, total continuing education credits required, total remaining continuing education credits needed, and/or compliance information.

19. A method for providing search, registration, management, auditing, and tracking of continuing education requirements, the method comprising:
transmitting, by a web server, data to at least one user computer configured to generate at least one of a plurality of user interfaces, the plurality of user interfaces comprising a professional interface, a corporate interface, a licensing body interface, and/or a provider interface;
building at least one account associated with at least one user;
storing at least one class associated with at least one attribute based at least partially upon data received from at least one user computer;
transmitting search result data to the at least one user computer at least partially based upon at least one received search query from the at least one user computer;
transmitting recommendation data, including class identification data, to the at least one user computer based at least partially on the result data;
generating registration data for at least one user at least partially based upon at least one received class selection from the at least one user computer;
generating completion data for at least one user at least partially based upon at least one received notification from the at least one user computer; and
transmitting status data for the at least one user to the at least one user computer.

20. A computer-readable storage medium storing computer-executable instructions that, when executed, cause a computer system to perform a method for searching, registering, auditing, managing and tracking of continuing education requirements, said method comprising:
transmitting, by a web server, data to at least one user computer configured to generate at least one of a plurality of user interfaces, the plurality of user interfaces comprising a professional interface, a corporate interface, a licensing body interface, and/or a provider interface;
building at least one account associated with at least one user;
storing at least one class associated with at least one attribute based at least partially upon data received from at least one user computer;
transmitting search result data to the at least one user computer at least partially based upon at least one received search query from the at least one user computer;
transmitting recommendation data, including class identification data, to the at least one user computer at least partially based at least partially on the result data;
generating registration data for at least one user at least partially based upon at least one received class selection from the at least one user computer;
generating completion data for at least one user based upon at least one received notification from the at least one user computer; and
transmitting status data for the at least one user to the at least one user computer.
